(19) United States
(12) Patent Application Publication
(10) Pub. No.: US 2022/0185993 A1
(43) Pub. Date: Jun. 16, 2022

(54) MIXED COMPOSITION

(71) Applicant: SUMITOMO CHEMICAL COMPANY, LIMITED, Tokyo (JP)

(72) Inventors: Masayoshi TOKUDA, Osaka-shi (JP); Sayaka SAKURAI, Tokyo (JP); Tomohiro ITO, Osaka-shi (JP)

(73) Assignee: SUMITOMO CHEMICAL COMPANY, LIMITED, Tokyo (JP)

(21) Appl. No.: 17/603,124

(22) PCT Filed: Apr. 1, 2020
(86) PCT No.: PCT/JP2020/015048

§ 371 Date: Oct. 12, 2021

(30) Foreign Application Priority Data
Apr. 23, 2019 (JP) 2019-081430

(51) Int. Cl. C08K 5/5419; C09D 183/04; C09D 183/16

(52) U.S. Cl. CPC C08K 5/5419; C09D 183/16; C09D 183/04

(57) ABSTRACT

The composition of the present invention is a mixed composition including at least one metal compound (G) selected from a metal compound represented by the following formula (G1) and a condensate thereof, a polysilazane (F), and a compound (H) including a siloxane chain. M(R^{g10})ᵣ(A^{g1})ₘ₋ᵣ (G1) wherein M represents Al, Fe, In, Ge, Hf, Si, Ti, Sn, Zr, or Ta, R^{g10} represents a hydrocarbon chain-containing group or a hydrogen atom, r is 0 or 1, a plurality of A^{g1} each independently represent a hydrolyzable group, and m is an integer of 3 to 5 in accordance with the metal atom M.

### TECHNICAL FIELD

The present invention relates to a mixed composition containing a polysilazane, a compound including a siloxane chain, and a metal compound.

### BACKGROUND ART

In various display devices, optical elements, semiconductor devices, building materials, automobile parts, nanoimprint technology, and the like, there are cases in which problems, such as contamination or corrosion of a base material, and in particular a deterioration in performance caused by such contamination or corrosion, arise due to droplets adhering to the surface of the base material. Therefore, in these fields, the surface of the base material needs to have good liquid repellency.

Patent Literature 1 discloses a coating composition obtained by mixing an organosilicon compound in which at least one trialkylsilyl group-containing molecular chain and at least one hydrolyzable group are bonded to a silicon atom and metal compound in which a hydrolyzable group is bonded to a metal atom, in which the coating film obtained from the coating composition can achieve good water and oil repellency, light resistance, and heat resistance. Further, Patent Literature 2 discloses a mixed composition containing an organosilicon compound having at least one trialkylsilyl group and two or more hydrolyzable silicon groups, and a metal compound in which at least one hydrolyzable group is bonded to a metal atom, and that this composition can provide a coating film having good heat resistance and light resistance in addition to water repellency.

### CITATION LIST

### Patent Literature

Patent Literature 1: International Publication No. 2016/068138

Patent Literature 2: Japanese Patent Laid-Open No. 2017-119849

### SUMMARY OF INVENTION

### Technical problem

However, in Patent Literature 1 and 2, there is still room for investigation of wear resistance. Further, there is also a problem in that when forming a coating film by curing a coating agent, heat is needed in order to form the coating film at a practical speed.

### Solution to Problem

As a result of intensive research to solve the above-described problems, the present inventors discovered that by using a mixed composition containing a compound including a polysilazane and a siloxane chain and a metal compound as a coating agent (composition for forming an intermediate layer) for an intermediate layer between a base material and a liquid-repellent layer, wear resistance when formed into a coating film is improved without impairing liquid repellency, and preferably, curing can be carried out at a practical speed even at room temperature, thereby completing the present invention. The present invention is as follows.
[1] A mixed composition comprising:

at least one metal compound (G) selected from a metal compound represented by the following formula (G1) and a condensate thereof;

a polysilazane (F); and

a compound (H) including a siloxane chain,

M(R^{g10})ᵣ(A^{g1})ₘ₋ᵣ (G1)

wherein M represents Al, Fe, In, Ge, Hf, Si, Ti, Sn, Zr, or Ta, R^{g10} represents a hydrocarbon chain-containing group or a hydrogen atom, r is 0 or 1, a plurality of A^{g1} each independently represent a hydrolyzable group, and m is an integer of 3 to 5 in accordance with the metal atom M.
[2] The composition according to [1], wherein a mass ratio of the compound (H) including a siloxane chain and the metal compound (G) to the total mass of the polysilazane (F), the compound (H) including a siloxane chain, and the metal compound (G) is 5 to 95%.
[3] The composition according to [1] or [2], wherein the polysilazane (F) has a structural unit represented by the following formula (f1):

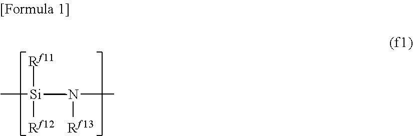

wherein R^{f11}, R^{f12}, and R^{f13} each independently represent a hydrogen atom, an optionally-substituted hydrocarbon group having 1 to 10 carbon atoms, or an alkylsilyl group.
[4] The composition according to [3], wherein the polysilazane (F) has a structural unit (f2) in which at least one of R^{f11} and R^{f12} in formula (f1) is a hydrocarbon group having 1 to 10 carbon atoms.
[5] The composition according to [4], wherein the polysilazane (F) has, in addition to the structural unit (f2), a structural unit represented by the following formula (f3):

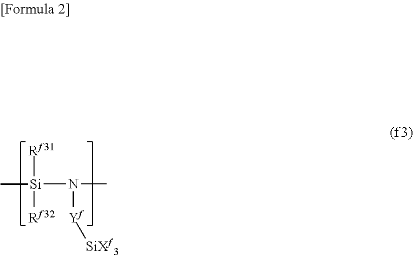

wherein R^{f31} and R^{f32} each independently represent a hydrogen atom or a hydrocarbon group having 1 to 10 carbon atoms, Y^{f} represents a divalent hydrocarbon group having 1 to 10 carbon atoms, and each of a plurality of X^{fs} independently represents a hydrolyzable group.
[6] The composition according to any one of [1] to [5], wherein the compound (H) including a siloxane chain is a compound represented by the following formula (H1):

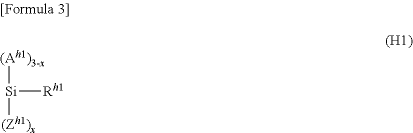

wherein R^{h1} represents a molecular chain having a trialkylsilyl group and a siloxane chain, each A^{h1} independently represents a hydrolyzable group, Z^{h1} represents a molecular chain having a trialkylsilyl group and a siloxane chain, a siloxane skeleton-containing group, or a hydrocarbon chain-containing group, a hydrogen atom included in the trialkylsilyl groups of R^{h1} and Z^{h1} is optionally replaced by a fluorine atom, and x represents an integer of 0 to 3.
[7] The compound according to [6], wherein R^{h1} in formula (H1) is a group represented by the following formula (s3):

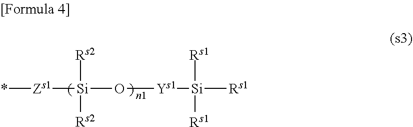

wherein each of a plurality of R^{s1} independently represents a hydrocarbon group or a trialkylsilyloxy group, a hydrogen atom included in the hydrocarbon group or the trialkylsilyloxy group is optionally replaced by a fluorine atom, each of a plurality of R^{s2} independently represents an alkyl group having 1 to 10 carbon atoms, n1 denotes an integer of 1 or more, Z^{s1} represents —O— or a divalent hydrocarbon group, —CH₂— included in the divalent hydrocarbon group is optionally replaced by —O—, Y^{s1} represents a single bond or —Si(R^{s2})₂-L^{s1}-, the Ls¹ represents a divalent hydrocarbon group, and —CH₂— included in the divalent hydrocarbon group is optionally replaced by —O—.
[8] The composition according to any one of [1] to [7], wherein the total amount of the polysilazane (F), the compound (H) including a siloxane chain, and the metal compound (G) is 0.2% by mass or more and less than 2.6% by mass.
[9] The composition according to any one of [1] to [8], wherein the amount of the compound (H) including a siloxane chain is less than 0.3% by mass.
[10] The composition according to any one of [1] to [9], which is for an intermediate layer between a base material and a liquid-repellent layer.
[11] The composition according to [10], wherein the liquid-repellent layer is a film formed by a dehydration condensation reaction of a silanol group.

It is noted that the term “mixed composition” includes compositions in which, after mixing, for example, a reaction has proceeded during storage.

### Advantageous Effects of Invention

A coating film having excellent wear resistance can be provided by using the mixed composition of the present invention as a composition for forming an intermediate layer. Further, as a preferred mode, a coating film can be cured at a practical speed even at room temperature by using the mixed composition of the present invention as a composition for forming an intermediate layer.

### DESCRIPTION OF EMBODIMENTS

Hereinafter, the polysilazane (F), the compound (H) including a siloxane chain, and the metal compound (G) will be described in order.

### 1. Polysilazane (F)

The polysilazane (F) in the present invention is not particularly limited as long as it is a compound having a silicon-nitrogen bond, but preferably it has a structural unit represented by the following formula (f1).

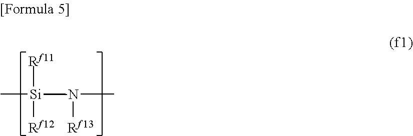

In formula (f1) , R^{f11}, R^{f12}, and R^{f13} each independently represent a hydrogen atom, an optionally-substituted hydrocarbon group having 1 to 10 carbon atoms, or an alkylsilyl group.

Examples of the hydrocarbon group having 1 to 10 carbon atoms represented by R^{f11} to R^{f13} include straight saturated aliphatic hydrocarbon groups such as a methyl group, an ethyl group, a propyl group, a butyl group, a pentyl group, a hexyl group, a heptyl group, an octyl group, a nonyl group, and a decyl group; branched saturated aliphatic hydrocarbon groups such as an isopropyl group, a sec-butyl group, a tert-butyl group, a methylpentyl group, an ethylpentyl group, a methylhexyl group, an ethylhexyl group, a propyl hexyl group, and a tert-octyl group; cyclic saturated aliphatic hydrocarbon groups such as a cyclopentyl group, a cyclohexyl group, a cycloheptyl group, and a cyclo-octyl group; unsaturated aliphatic hydrocarbon groups such as a vinyl group, a 1-propenyl group, a 2-propenyl group, a 1-butenyl group, a 2-butenyl group, and a 3-butenyl group; aromatic hydrocarbon groups such as a phenyl group, a naphthyl group, a p-tert-butylphenyl group, a tolyl group, a xylyl group, a cumenyl group, a mesityl group, a 2,6-diethylphenyl group, and a 2-methyl-6-ethylphenyl group; and groups combining of the hydrocarbon groups mentioned here, such as an alkylcycloalkyl group, a cycloalkylalkyl group, and an aralkyl group.

Examples of the substituent that the hydrocarbon group having 1 to 10 carbon atoms optionally has include: a halogen atom selected from a fluorine atom, a chlorine atom, a bromine atom, and an iodine atom; a hydroxy group; a nitro group; an amino group; a cyano group; a thiol group; an epoxy group; a glycidoxy group; a (meth)acroyloxy group; a heteroaryl group having 6 to 12 atoms forming a ring; an alkoxy group having 1 to 3 carbon atoms, such as a methoxy group and an ethoxy group; an aryloxy group having 6 to 12 carbon atoms forming a ring; and the like.

The hydrocarbon group having 1 to 10 carbon atoms represented by R^{f11} to R^{f13} is preferably an unsubstituted saturated aliphatic hydrocarbon group having 1 to 10 carbon atoms, more preferably an unsubstituted saturated aliphatic hydrocarbon group having 1 to 6 carbon atoms, and further preferably an unsubstituted methyl group, ethyl group, propyl group, or butyl group, and most preferably a methyl group.

Examples of the alkylsilyl group represented by R^{f11} to R^{f13} include a trimethylsilyl group, a triethylsilyl group, a tri-n-propylsilyl group, a tri-isopropylsilyl group, a tri-t-butylsilyl group, a methyldiethylsilyl group, a dimethylsilyl group, a diethylsilyl group, a methylsilyl group, an ethylsilyl group, and the like.

The polysilazane (F) is preferably an organic polysilazane having a structural unit (f2) in which at least one of R^{f11} and R^{f12} in formula (f1) is a hydrocarbon group having 1 to 10 carbon atoms. Further, R^{f13} is preferably a hydrogen atom.

It is more preferable that, in addition to the structural unit (f2), the polysilazane (F) additionally has a structural unit represented by the following formula (f3).

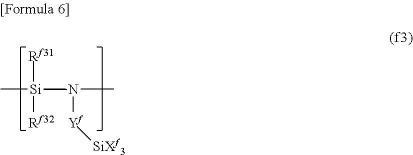

In formula (f3) , R^{f31} and R^{f32} each independently represent a hydrogen atom or a hydrocarbon group having 1 to 10 carbon atoms, Y^{f} represents a divalent hydrocarbon group having 1 to 10 carbon atoms, and each of a plurality of X^{fs} independently represents a hydrolyzable group.

Examples of the hydrocarbon group having 1 to 10 carbon atoms represented by R^{f31} and R^{f32} include the same groups as those described for the hydrocarbon group having 1 to 10 carbon atoms represented by R^{f11} to R^{f13}. Among them, a saturated aliphatic hydrocarbon group having 1 to 10 carbon atoms is preferable, more preferable is a straight saturated aliphatic hydrocarbon group having 1 to 6 carbon atoms, and further preferable is a methyl group, an ethyl group, a propyl group, or a butyl group.

The number of carbon atoms of the divalent hydrocarbon group represented by Y^{f} is preferably 1 to 4, more preferably 1 to 3, and further preferably 1 to 2. The divalent hydrocarbon group is preferably in the form of a chain, and when it is in the form of a chain, the divalent hydrocarbon group may be in the form of straight or branched chain. The divalent hydrocarbon group is preferably a divalent aliphatic hydrocarbon group, and preferably an alkanediyl group. Examples of the divalent hydrocarbon group include a methylene group, an ethylene group, a propylene group, a butylene group, and the like.

Further, some of the —CH₂— included in the divalent hydrocarbon group may be replaced by —O—. In this case, two consecutive —CH₂— are not replaced by —O— at the same time, and a —CH₂— adjacent to the Si atom is not replaced by —O—. When two or more —CH₂— are replaced by —O—, the number of carbon atoms between —O— and —O— is preferably 2 to 4, and more preferably 2 to 3. Specific examples of the group in which some of the divalent hydrocarbon groups are replaced by —O— include a group having a (poly)ethylene glycol unit, a group having a (poly)propylene glycol unit, and the like.

The hydrolyzable group represented by X^{f} may be any group that gives a hydroxy group (silanol group) by hydrolysis. Preferable examples thereof include an alkoxy group having 1 to 4 carbon atoms, such as a methoxy group, an ethoxy group, a propoxy group, and a butoxy group; a hydroxy group; an acetoxy group; a chlorine atom; an isocyanate group; and the like. Among these, an alkoxy group having 1 to 4 carbon atoms is preferable, and an alkoxy group having 1 to 2 carbon atoms is more preferable. The plurality of X^{f}s may be the same or different, but are preferably the same.

The content of the SiX^{f}₃ group of formula (f3) is, based on 100% by mass of the polysilazane (F), preferably 2% by mass or more, more preferably 5% by mass or more, and further preferably 8% by mass or more. The upper limit is not limited, but it may be 50% by mass or less, 40% by mass or less, or 30% by mass or less.

When the polysilazane (F) is an organic polysilazane, the content ratio of the hydrogen atom of Si—H and the hydrocarbon group having 1 to 10 carbon atoms bonded to the Si can be appropriately selected. For example, the molar ratio of the hydrocarbon group/hydrogen atom is 0.1 to 50, and preferably 0.2 to 10. The molar ratio can be calculated from NMR measurement and the like.

The amount of the polysilazane (F) is, based on the whole composition of 100% by mass, preferably 0.01% by mass or more, more preferably 0.05% by mass or more, further preferably 0.1% by mass or more, and still further preferably 0.3% by mass or more, and is preferably 2.5% by mass or less, more preferably 2% by mass or less, further preferably 1.5% by mass or less, and still further preferably 1% by mass or less.

### 2. Compound (H) Containing a Siloxane Chain

The compound (H) containing a siloxane chain in the present invention is not particularly limited as long as it is a compound having at least one siloxane bond. The siloxane chain may be a straight chain or branched, but is preferably a straight chain.

The siloxane chain preferably includes a dialkylsiloxane chain, and more preferably contains a straight dialkylsiloxane chain. Further, the siloxane chain may further contain a divalent group other than the siloxane bond. Examples of the divalent group include a divalent hydrocarbon group, a group in which some of the methylene groups (—CH₂—) of the divalent hydrocarbon group are replaced by oxygen atoms, —O—, and the like.

It is preferable that a silyl group is bonded to the end of the siloxane chain. A silyl group is a group in which three substituents are bonded to a silicon atom. Examples of the substituents include a hydrogen atom, a hydrocarbon chain-containing group, an alkylsilyloxy group, a hydrolyzable group, and the like.

The term hydrocarbon chain-containing group means a group having a hydrocarbon chain in at least a portion thereof. Usually, the hydrocarbon chain-containing group is composed of only hydrocarbon groups (hydrocarbon chains), but if necessary, the hydrocarbon chain-containing group may be a group in which some of the methylene groups (—CH₂—) of the hydrocarbon chain are replaced by oxygen atoms. Further, a methylene group (—CH₂—) adjacent to the Si atom is not replaced by an oxygen atom, and two consecutive methylene groups (—CH₂—) are not replaced by oxygen atoms at the same time.

The number of carbon atoms of the hydrocarbon chain-containing group means, for a non-oxygen-substituted hydrocarbon chain-containing group, the number of carbon atoms constituting the hydrocarbon group (hydrocarbon chain), and for an oxygen-substituted hydrocarbon chain-containing group, the number of carbon atoms constituting the hydrocarbon group (hydrocarbon chain) counted by assuming that the oxygen atoms are a methylene group (—CH₂—).

Hereinafter, unless otherwise specified, the hydrocarbon chain-containing group is described based on the example of a non-oxygen-substituted hydrocarbon chain-containing group (that is, a monovalent hydrocarbon group) as an example, but in the entire description below, it is possible to replace some of the methylene groups (—CH₂—) constituting the hydrocarbon chain-containing group by oxygen atoms.

When the hydrocarbon chain-containing group is a hydrocarbon group, the hydrocarbon chain-containing group preferably has 1 or more and 3 or less carbon atoms, and more preferably 1 carbon atom. Further, the hydrocarbon chain-containing group may be a branched chain or a straight chain. The hydrocarbon chain-containing group is preferably a saturated or unsaturated aliphatic hydrocarbon chain-containing group, and more preferably a saturated aliphatic hydrocarbon chain-containing group. As the saturated aliphatic hydrocarbon chain-containing group, a saturated aliphatic hydrocarbon group (alkyl group) is more preferable. Examples of the saturated aliphatic hydrocarbon group include a methyl group, an ethyl group, a propyl group, and the like.

When some of the methylene groups (—CH₂—) of the saturated aliphatic hydrocarbon group are replaced by an oxygen atom, specific examples include a group having a (poly)ethylene glycol unit.

The hydrolyzable group may be any group that gives a hydroxy group (silanol group) by hydrolysis. Preferable examples thereof include an alkoxy group having 1 to 6 carbon atoms, such as a methoxy group, an ethoxy group, a propoxy group, and a butoxy group; a hydroxy group; an acetoxy group; a chlorine atom; an isocyanate group; and the like. Among these, an alkoxy group having 1 to 6 carbon atoms is preferable, an alkoxy group having 1 to 4 carbon atoms is more preferable, and an alkoxy group having 1 or 2 carbon atoms is further preferable.

Examples of the alkylsilyloxy group include a monoalkylsilyloxy group, a dialkylsilyloxy group, and a trialkylsilyloxy group, and among them, a trialkylsilyloxy group is preferable. Examples of the trialkylsilyloxy group include a trimethylsilyloxy group, a triethylsilyloxy group, and a tripropylsilyloxy group.

When one silicon atom has a plurality of substituents, the plurality of substituents may be the same or different.

It is preferable that the end of the siloxane chain is bonded to a silicon atom to which at least one hydrolyzable group is bonded, more preferably to a silicon atom to which two or more hydrolyzable groups are bonded, and further preferably to a silicon atom to which three hydrolyzable groups are bonded. The silicon atom to which the hydrolyzable group(s) is/are bonded may be bonded to one end of the siloxane chain or to both ends of the siloxane chain, but is preferably bonded only to one end.

It is more preferable that both ends of the siloxane chain are bonded to any one of a silyl group having three alkoxy groups as substituents (trialkoxysilyl group), a silyl group having three alkyl groups as substituents (trialkylsilyl group), and a silyl group having three trialkylsilyloxy groups as substituents (tris(trialkylsilyloxy)silyl group). It is particularly preferable that one end is bonded to a trialkoxysilyl group and the other end is bonded to a trialkylsilyl group or to a tris(trialkylsilyloxy)silyl group.

A more preferable mode of the compound (H) including a siloxane chain of the present invention is a compound in which a molecular chain having a trialkylsilyl group and a siloxane chain (hereinafter, this molecular chain is sometimes referred to as “molecular chain (ts1)”) is bonded to at least one silicon atom (hereinafter, this silicon atom is sometimes referred to as “central silicon atom”).

In the compound (H) including a siloxane chain, the number of molecular chains (ts1) bonded to the central silicon atom is preferably 1 or more, and is preferably 3 or less, more preferably 2 or less, and particularly preferably 1.

The central silicon atom of the compound (H) including a siloxane chain may be bonded to, in addition to the molecular chain (ts1), a hydrolyzable group, a siloxane skeleton-containing group having fewer atoms than the number of atoms constituting the molecular chain (ts1), or a hydrocarbon chain-containing group containing a hydrocarbon chain having fewer carbon atoms than the number of atoms constituting the molecular chain (ts1).

Specifically, the compound (H) including a siloxane chain is preferably a compound represented by the following formula (H1).

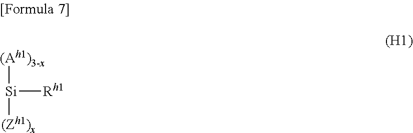

In formula (H1), R^{h1} represents a molecular chain having a trialkylsilyl group and a siloxane chain, each A^{h1} independently represents a hydrolyzable group, Z^{h1} represents a molecular chain having a trialkylsilyl group and a siloxane chain, a siloxane skeleton-containing group, or a hydrocarbon chain-containing group, a hydrogen atom included in the trialkylsilyl groups of R^{h1} and Z^{h1} is optionally replaced by a fluorine atom, and x denotes an integer of 0 to 3.

The molecular chain (molecular chain (ts1)) having a trialkylsilyl group and a siloxane chain of R^{h1} is a monovalent group having a structure in which the trialkylsilyl-containing group is bonded to an end of the siloxane chain. The alkyl group of the trialkylsilyl-containing group is optionally replaced by a fluoroalkyl group.

The trialkylsilyl-containing group is a group that includes at least one trialkylsilyl group, and includes preferably two or more trialkylsilyl groups, and more preferably three trialkylsilyl groups. The trialkylsilyl-containing group is preferably a group represented by formula (s1).

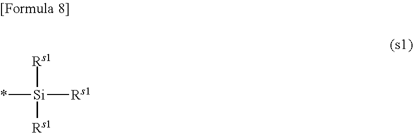

In formula (s1) , each of a plurality of R^{s1} independently represents a hydrocarbon group or a trialkylsilyloxy group, a hydrogen atom included in the hydrocarbon group or the trialkylsilyloxy group is optionally replaced by a fluorine atom, and * represents a bond.

In formula (s1), it is preferable that at least one R^{s1} trialkylsilyloxy group, or that all the R^{s1}s are alkyl groups.

When the R^{s1}s are hydrocarbon groups, the number of carbon atoms thereof is preferably 1 to 4, more preferably 1 to 3, and further preferably 1 or 2. When the R^{s1}s are hydrocarbon groups, an aliphatic hydrocarbon group is preferable, and an alkyl group is more preferable. Examples of the alkyl group include a methyl group, an ethyl group, a propyl group, a butyl group, and the like. The plurality of R^{s1}s may be the same or different, but are preferably the same. When all the Rsls are hydrocarbon groups (particularly alkyl groups), the total number of carbon atoms of three R^{s1}s is preferably 9 or less, more preferably 6 or less, and further preferably 4 or less. It is preferable that at least one of the three R^{s1}s is a methyl group, more preferably that at least two are methyl groups, and particularly preferably that all three R^{s1}s are methyl groups.

Specific examples of the group (trialkylsilyl group) in which all of the R^{s1}s are hydrocarbon groups (alkyl groups) include groups represented by the following formulas. In the formula, * represents a bond.

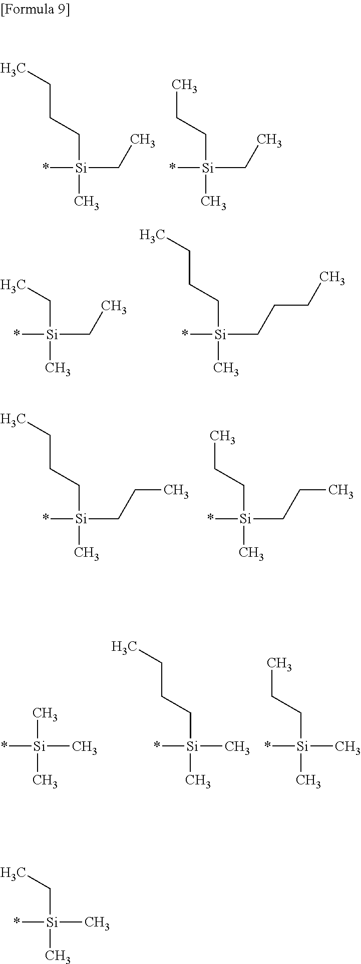

Examples of the trialkylsilyloxy group include a group in which an oxygen atom is bonded to the silicon atom of a group (trialkylsilyl group) in which all of the R^{s1}s are hydrocarbon groups (alkyl groups). In formula (s1), it is preferable that at least one R^{s1} is a trialkylsilyloxy group, more preferably two or more R^{s1}s are trialkylsilyloxy groups, and further preferably three R^{s1}sare trialkylsilyloxy groups.

Examples of the group in which at least one R^{s1} is a trialkylsilyloxy group include groups represented by the following formulas.

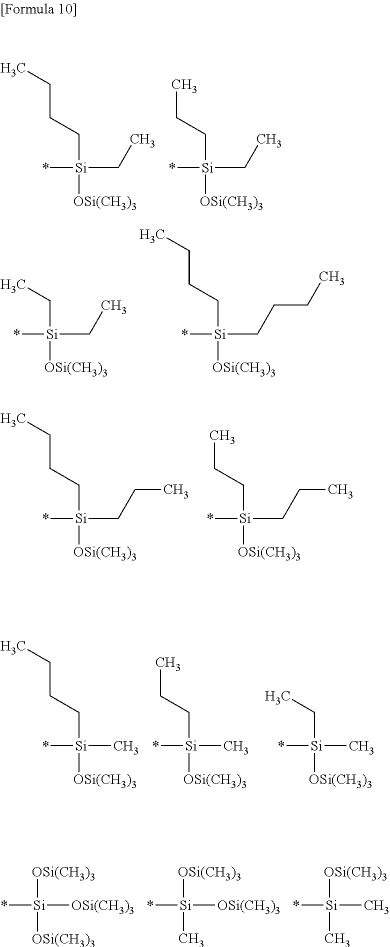

In the molecular chain (ts1), the trialkylsilyl-containing group is preferably bonded to an end (free end side) of the siloxane chain, and particularly to an end (free end side) of the main chain (longest straight chain) of the siloxane chain.

The siloxane chain to which the trialkylsilyl-containing group is bonded is the same as the siloxane chain described above, and preferably includes a straight dialkylsiloxane chain. Further, the siloxane chain may include a divalent hydrocarbon group. Even if some of the siloxane chain are a divalent hydrocarbon group, the rest is a dialkylsiloxane chain, and therefore the obtained coating film has good chemical and physical durability.

The siloxane chain is preferably a group represented by the following formula (s2).

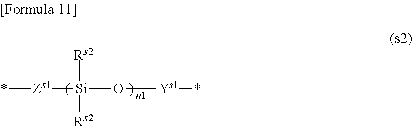

In formula (s2), each of a plurality of R^{s2} independently represents an alkyl group having 1 to 10 carbon atoms, Z^{s1} represents —O— or a divalent hydrocarbon group, —CH₂— included in the divalent hydrocarbon group is optionally replaced by —O—, Y^{s1} represents a single bond or —Si(R^{s2})₂-L^{s1}-, the L^{s1} represents a divalent hydrocarbon group, —CH₂— included in the divalent hydrocarbon group is optionally replaced by —O—, * on the left side of formula (s2) represents a bond with a central silicon atom, * on the right side of formula (s2) represents a bond with a trialkylsilyl-containing group, and n1 is an integer of 1 or more.

The number of carbon atoms of R^{s2} is preferably 1 to 4, more preferably 1 to 3, and further preferably 1 to 2.

n1 is preferably 1 to 100, more preferably 1 to 80, further preferably 1 to 60, still further preferably 1 to 50, and particularly preferably 1 to 30.

The number of carbon atoms of the divalent hydrocarbon group represented by Z^{s1} or L^{s1} is preferably 1 to 10, more preferably 1 to 6, and further preferably 1 to 4. The divalent hydrocarbon group is preferably in the form of a chain, and when it is in the form of a chain, the divalent hydrocarbon group may be in the form of straight or branched chain. The divalent hydrocarbon group is preferably a divalent aliphatic hydrocarbon group, and preferably an alkanediyl group. Examples of the divalent hydrocarbon group include a methylene group, an ethylene group, a propylene group, a butylene group, and the like.

Further, some of the —CH₂— included in the divalent hydrocarbon group may be replaced by —O—. In this case, two consecutive —CH₂— are not replaced by —O— at the same time, and a —CH₂— adjacent to the Si atom is not replaced by —O—. When two or more —CH₂— are replaced by —O—, the number of carbon atoms between —O— and —O— is preferably 2 to 4, and more preferably 2 to 3. Specific examples of the group in which some of the divalent hydrocarbon group are replaced by —O— include a group having a (poly)ethylene glycol unit, a group having a (poly)propylene glycol unit, and the like.

In formula (s2), it is preferable that Z^{s1} is —O—and Y^{s1} is a single bond, that is, the siloxane chain consists only of repeating dialkylsilyloxy groups. When the dialkylsiloxane chain consists only of repeating dialkylsilyloxy groups, the obtained coating film has good chemical and physical durability.

Examples of the siloxane chain included in the molecular chain (ts1) include the siloxane chains represented by the following formulas. In the following formulas, q1 represents an integer of 1 to 60, and * represents a bond that binds to the central silicon atom or a trialkylsilyl-containing group.

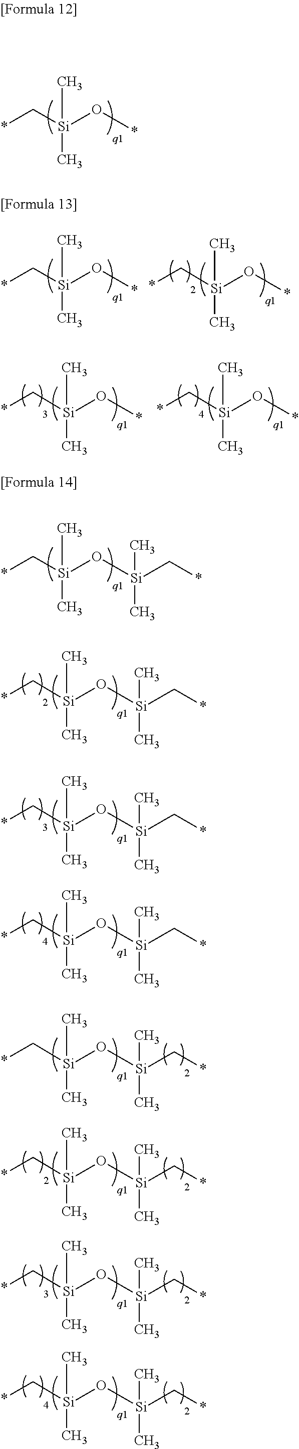

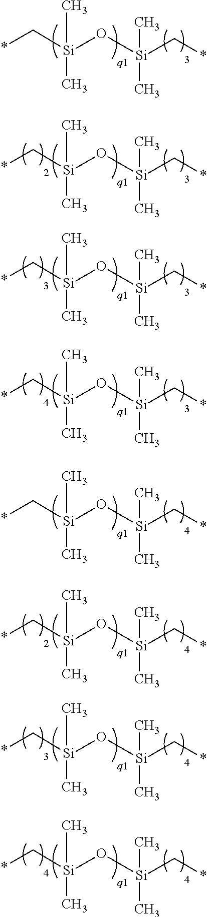

Further, the total number of atoms constituting the molecular chain (ts1) is preferably 24 or more, more preferably 40 or more, and further preferably 50 or more, and is preferably 5000 or less, more preferably 4000 or less, further preferably 2000 or less, still further preferably 1200 or less, particularly preferably 700 or less, and most preferably 250 or less.

The molecular chain (ts1) is preferably a group represented by the following formula (s3).

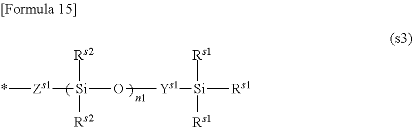

In formula (s3) , R^{s1}, R^{s2}, Z^{s1}, Y^{s1}, and n1 have the same meaning as described above, and * represents a bond with the central silicon atom.

The molecular chain (ts1) is preferably a group represented by the following formula (s3-1), and more preferably a group represented by the following formula (s3-1-1).

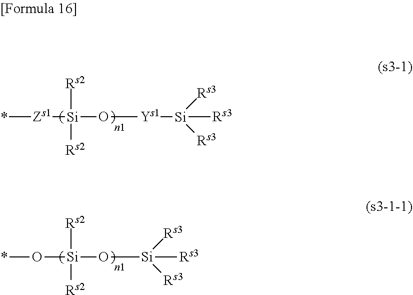

In formula (s3-1) and formula (s3-1-1), R^{s2}, Y^{s1}, Z^{s1}, and n1 have the same meaning as described above, R^{s3} represents an alkyl group having 1 to 4 carbon atoms, and * represents a bond with the central silicon atom.

The number of carbon atoms of the alkyl group represented by R^{s3} is preferably 1 to 3, and more preferably 1 or 2. Further, in formula (s3-1) and formula (s3-1-1), the total number of carbon atoms of the R^{s3} included in —Si(R^{s3})₃ is preferably 9 or less, more preferably 6 or less, and further preferably 4 or less.

In addition, of the R^{s3}s included in —Si(R^{s3})₃, it is preferable that at least one R^{s3} is a methyl group, more preferable that two or more R^{s3}s are methyl groups, and particularly preferable that all three R^{s3}s are methyl groups.

Further, the molecular chain (ts1) is further preferably a group represented by the following formula (s3-2), and particularly preferably is a group represented by the following formula (s3-2-1).

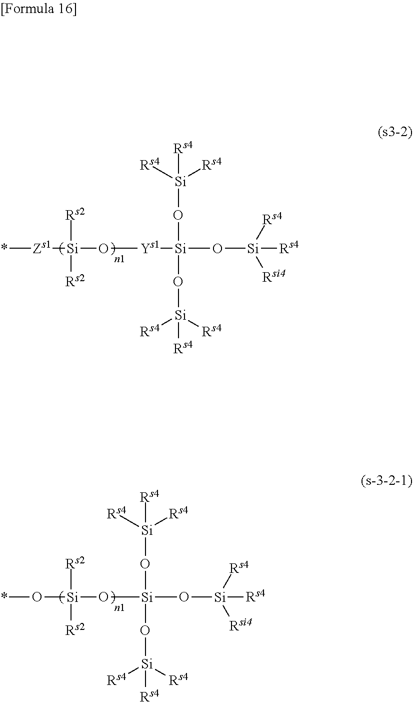

In formula (s3-2) and formula (s3-2-1), R^{s2}, Y^{s1}, Z^{s1}, and n1 have the same meaning as described above, R^{s4} represents an alkyl group having 1 to 4 carbon atoms, and * represents a bond with the central silicon atom.

Examples of the alkyl group having 1 to 4 carbon atoms represented by R^{s4} include the groups described above for R^{s3}, and the preferred range is also the same.

Examples of the molecular chain (ts1) include the groups represented by formula (s3-I). In formula (s3-I), * represents a bond with the central silicon atom.

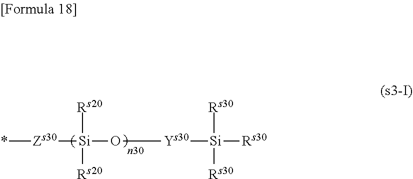

TABLE 1

| | Z^{s30} | R^{s20} | n30 | Y^{s30} | R^{s30} |
|---|---|---|---|---|---|
| (s3-I-1) | *—O—* | CH₃—* | 1~60 | — | (CH₃)₃SiO—* |
| (s3-I-2) | *—O—* | CH₃—* | 1~60 | *—Si(CH₃)₂—CH₂—* | (CH₃)₃SiO—* |
| (s3-I-3) | *—O—* | CH₃—* | 1~60 | *—Si(CH₃)₂—(CH₂)₂—* | (CH₃)₃SiO—* |
| (s3-I-4) | *—O—* | CH₃—* | 1~60 | *—Si(CH₃)₂—(CH₂)₃—* | (CH₃)₃SiO—* |
| (s3-I-5) | *—O—* | CH₃—* | 1~60 | *—Si(CH₃)₂—(CH₂)₄—* | (CH₃)₃SiO—* |
| (s3-I-6) | *—CH₂—* | CH₃—* | 1~60 | — | (CH₃)₃SiO—* |
| (s3-I-7) | *—CH₂—* | CH₃—* | 1~60 | *—Si(CH₃)₂—CH₂—* | (CH₃)₃SiO—* |
| (s3-I-8) | *—CH₂—* | CH₃—* | 1~60 | *—Si(CH₃)₂—(CH₂)₂—* | (CH₃)₃SiO—* |
| (s3-I-9) | *—CH₂—* | CH₃—* | 1~60 | *—Si(CH₃)₂—(CH₂)₃—* | (CH₃)₃SiO—* |
| (s3-I-10) | *—CH₂—* | CH₃—* | 1~60 | *—Si(CH₃)₂—(CH₂)₄—* | (CH₃)₃SiO—* |
| (s3-I-11) | *—(CH₂)₂—* | CH₃—* | 1~60 | — | (CH₃)₃SiO—* |
| (s3-I-12) | *—(CH₂)₂—* | CH₃—* | 1~60 | *—Si(CH₃)₂—CH₂—* | (CH₃)₃SiO—* |
| (s3-I-13) | *—(CH₂)₂—* | CH₃—* | 1~60 | *—Si(CH₃)₂—(CH₂)₂—* | (CH₃)₃SiO—* |
| (s3-I-14) | *—(CH₂)₂—* | CH₃—* | 1~60 | *—Si(CH₃)₂—(CH₂)₃—* | (CH₃)₃SiO—* |
| (s3-I-15) | *—(CH₂)₂—* | CH₃—* | 1~60 | *—Si(CH₃)₂—(CH₂)₄—* | (CH₃)₃SiO—* |
| (s3-I-16) | *—(CH₂)₃—* | CH₃—* | 1~60 | — | (CH₃)₃SiO—* |
| (s3-I-17) | *—(CH₂)₃—* | CH₃—* | 1~60 | *—Si(CH₃)₂—CH₂—* | (CH₃)₃SiO—* |
| (s3-I-18) | *—(CH₂)₃—* | CH₃—* | 1~60 | *—Si(CH₃)₂—(CH₂)₂—* | (CH₃)₃SiO—* |
| (s3-I-19) | *—(CH₂)₃—* | CH₃—* | 1~60 | *—Si(CH₃)₂—(CH₂)₃—* | (CH₃)₃SiO—* |
| (s3-I-20) | *—(CH₂)₃—* | CH₃—* | 1~60 | *—Si(CH₃)₂—(CH₂)₄—* | (CH₃)₃SiO—* |
| (s3-I-21) | *—(CH₂)₄—* | CH₃—* | 1~60 | — | (CH₃)₃SiO—* |
| (s3-I-22) | *—(CH₂)₄—* | CH₃—* | 1~60 | *—Si(CH₃)₂—CH₂—* | (CH₃)₃SiO—* |
| (s3-I-23) | *—(CH₂)₄—* | CH₃—* | 1~60 | *—Si(CH₃)₂—(CH₂)₂—* | (CH₃)₃SiO—* |
| (s3-I-24) | *—(CH₂)₄—* | CH₃—* | 1~60 | *—Si(CH₃)₂—(CH₂)₃—* | (CH₃)₃SiO—* |
| (s3-I-25) | *—(CH₂)₄—* | CH₃—* | 1~60 | *—Si(CH₃)₂—(CH₂)₄—* | (CH₃)₃SiO—* |

TABLE 2

| | Z^{s30} | R^{s20} | n30 | Y^{s30} | R^{s30} |
|---|---|---|---|---|---|
| (s3-I-26) | *—O—* | CH₃—* | 1~60 | — | CH₃—* |
| (s3-I-27) | *—O—* | CH₃—* | 1~60 | *—Si(CH₃)₂—CH₂—* | CH₃—* |
| (s3-I-28) | *—O—* | CH₃—* | 1~60 | *—Si(CH₃)₂—(CH₂)₂—* | CH₃—* |
| (s3-I-29) | *—O—* | CH₃—* | 1~60 | *—Si(CH₃)₂—(CH₂)₃—* | CH₃—* |
| (s3-I-30) | *—O—* | CH₃—* | 1~60 | *—Si(CH₃)₂—(CH₂)₄—* | CH₃—* |
| (s3-I-31) | *—CH₂—* | CH₃—* | 1~60 | — | CH₃—* |
| (s3-I-32) | *—CH₂—* | CH₃—* | 1~60 | *—Si(CH₃)₂—CH₂—* | CH₃—* |
| (s3-I-33) | *—CH₂—* | CH₃—* | 1~60 | *—Si(CH₃)₂—(CH₂)₂—* | CH₃—* |
| (s3-I-34) | *—CH₂—* | CH₃—* | 1~60 | *—Si(CH₃)₂—(CH₂)₃—* | CH₃—* |
| (s3-I-35) | *—CH₂—* | CH₃—* | 1~60 | *—Si(CH₃)₂—(CH₂)₄—* | CH₃—* |
| (s3-I-36) | *—(CH₂)₂—* | CH₃—* | 1~60 | — | CH₃—* |
| (s3-I-37) | *—(CH₂)₂—* | CH₃—* | 1~60 | *—Si(CH₃)₂—CH₂—* | CH₃—* |
| (s3-I-38) | *—(CH₂)₂—* | CH₃—* | 1~60 | *—Si(CH₃)₂—(CH₂)₂—* | CH₃—* |
| (s3-I-39) | *—(CH₂)₂—* | CH₃—* | 1~60 | *—Si(CH₃)₂—(CH₂)₃—* | CH₃—* |
| (s3-I-40) | *—(CH₂)₂—* | CH₃—* | 1~60 | *—Si(CH₃)₂—(CH₂)₄—* | CH₃—* |
| (s3-I-41) | *—(CH₂)₃—* | CH₃—* | 1~60 | — | CH₃—* |
| (s3-I-42) | *—(CH₂)₃—* | CH₃—* | 1~60 | *—Si(CH₃)₂—CH₂—* | CH₃—* |
| (s3-I-43) | *—(CH₂)₃—* | CH₃—* | 1~60 | *—Si(CH₃)₂—(CH₂)₂—* | CH₃—* |
| (s3-I-44) | *—(CH₂)₃—* | CH₃—* | 1~60 | *—Si(CH₃)₂—(CH₂)₃—* | CH₃—* |
| (s3-I-45) | *—(CH₂)₃—* | CH₃—* | 1~60 | *—Si(CH₃)₂—(CH₂)₄—* | CH₃—* |
| (s3-I-46) | *—(CH₂)₄—* | CH₃—* | 1~60 | — | CH₃—* |
| (s3-I-47) | *—(CH₂)₄—* | CH₃—* | 1~60 | *—Si(CH₃)₂—CH₂—* | CH₃—* |
| (s3-I-48) | *—(CH₂)₄—* | CH₃—* | 1~60 | *—Si(CH₃)₂—(CH₂)₂—* | CH₃—* |
| (s3-I-49) | *—(CH₂)₄—* | CH₃—* | 1~60 | *—Si(CH₃)₂—(CH₂)₃—* | CH₃—* |
| (s3-I-50) | *—(CH₂)₄—* | CH₃—* | 1~60 | *—Si(CH₃)₂—(CH₂)₄—* | CH₃—* |

The n30 shown in Tables 1 and 2 is preferably 1 to 30.

Next, the A^{h1} in formula (H1) will be described. Each A^{h1} may independently be a hydrolyzable group that gives a hydroxy group (silanol group) by hydrolysis. Preferable examples thereof include an alkoxy group having 1 to 6 carbon atoms, such as a methoxy group, an ethoxy group, a propoxy group, and a butoxy group; a hydroxy group; an acetoxy group; a chlorine atom; an isocyanate group; and the like. Among these, an alkoxy group having 1 to 6 carbon atoms is preferable, an alkoxy group having 1 to 4 carbon atoms is more preferable, and an alkoxy group having 1 to 2 carbon atoms is further preferable.

Z^{h1} in formula (H1) represents a molecular chain having a trialkylsilyl group and a siloxane chain, a siloxane skeleton-containing group, or a hydrocarbon chain-containing group. When Z^{h1} is a molecular chain having a trialkylsilyl group and a siloxane chain, examples of Z^{h1} include the same as those described above for R^{h1}.

When Z^{h1} is a siloxane skeleton-containing group, it is preferable that the siloxane skeleton-containing group be a monovalent group containing a siloxane unit (Si—O—), and be constituted from a fewer number of atoms than the number of atoms constituting the molecular chain (ts1) of R^{h1}. As a result, the siloxane skeleton-containing group becomes a group having a shorter length or a smaller steric size (bulk) than the molecular chain (ts1). The siloxane skeleton-containing group may include a divalent hydrocarbon group.

The siloxane skeleton-containing group is preferably a group represented by the following formula (s4).

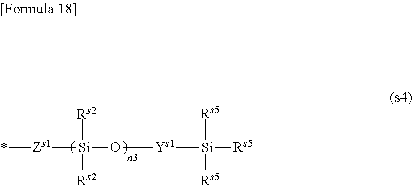

In formula (s4) , R^{s2}_{, Z}^{s1}, and Y^{s1} have the same meaning as described above, R^{s5} represents a hydrocarbon group or a hydroxy group, the —CH₂— included in the hydrocarbon group is optionally replaced by —O—, a hydrogen atom included in the hydrocarbon group is optionally replaced by a fluorine atom, n3 represents an integer of 0 to 5, and * represents a bond with the central silicon atom.

Examples of the hydrocarbon group represented by R^{s5} include the same groups as those of the hydrocarbon group represented by R^{s1}. Preferably, the hydrocarbon group is an aliphatic hydrocarbon group, and more preferably an alkyl group. The number of carbon atoms is preferably 1 to 4, more preferably 1 to 3, and further preferably 1 to 2.

n3 is preferably 1 to 5, and more preferably 1 to 3.

The total number of atoms of the siloxane skeleton-containing group is preferably 600 or less, more preferably 500 or less, further preferably 350 or less, still further preferably 100 or less, particularly preferably 50 or less, and most preferably 30 or less, and is preferably 10 or more. Further, the difference in the number of atoms between the molecular chain (ts1) of R^{h1} and the siloxane skeleton-containing group of Z^{h1} is preferably 10 or more, and more preferably 20 or more, and is preferably 1000 or less, more preferably 500 or less, and further preferably 200 or less.

Specific examples of the siloxane skeleton-containing group include the groups represented by the following formulas.

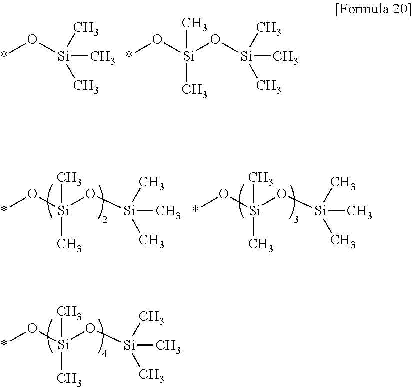

When Z^{h1} is a hydrocarbon chain-containing group, it is preferable that the number of carbon atoms of the hydrocarbon chain moiety is fewer than the number of atoms constituting the molecular chain (ts1) of R^{h1}. Further, it is preferable that the number of carbon atoms of the longest straight chain of the hydrocarbon chain is fewer than the number of atoms constituting the longest straight chain of the molecular chain (ts1). Examples of the hydrocarbon chain-containing group include the same groups described above as examples of a hydrocarbon chain-containing group.

In formula (H1), x is preferably 2 or less, more preferably 0 or 1, and further preferably 0.

The compound (H) including a siloxane chain represented by formula (H1) is preferably a compound represented by the following formula (H2).

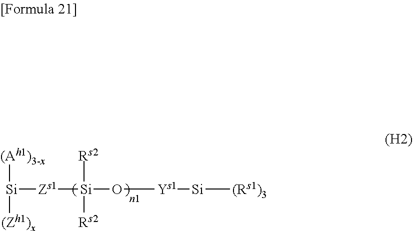

In formula (H2) , R^{s1}, R^{s2}, Z^{s1}, Y^{s1}, n1, A^{h1}, Z^{h1} and x each have the same meaning as described above.

The compound (H) including a siloxane chain represented by formula (H2) is preferably a compound represented by the following formula (H2-1), and more preferably a compound represented by formula (H2-1-1).

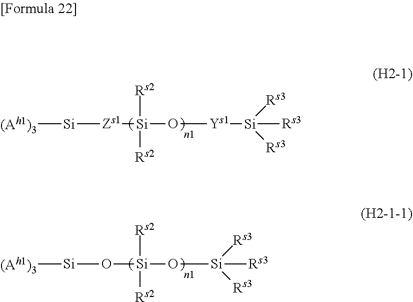

In formulas (H2-1) and (H2-1-1) , R^{s2}, R^{s3}, Y^{s1}, Z^{s1}, n1, and A^{h1} have the same meaning as described above.

The compound (H) including a siloxane chain represented by formula (H2) is further preferably a compound represented by the following formula (H2-2), and particularly preferably a compound represented by formula (H2-2-1).

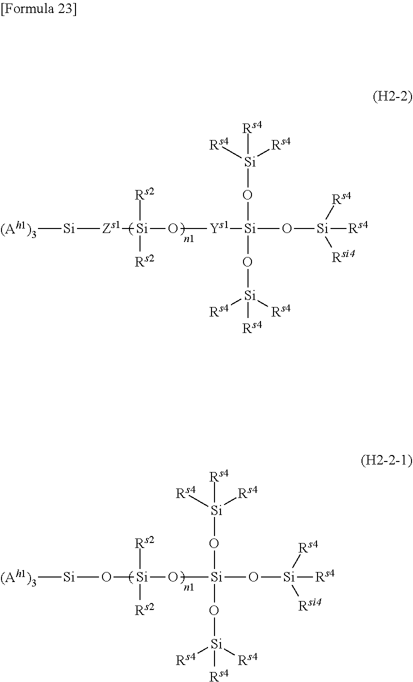

In formulas (H2-2) and (H2-2-1) , R^{s2}, R^{s4}, Y^{s1}, Z^{s1}, n1, and A^{h1} have the same meaning as described above.

Specific examples of the compound (H) including a siloxane chain represented by formula (H2) include the compound represented by formula (H2-I).

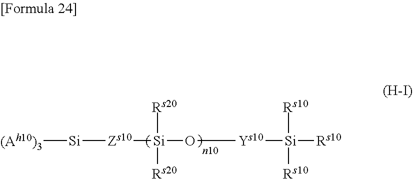

TABLE 3-1

| | A^{h10} | Z^{s10} | R^{s20} | n10 | Y^{s10} | R^{s10} |
|---|---|---|---|---|---|---|
| (H-I-1) | C₂H₅O—* | *—O—* | CH₃—* | 1~60 | — | (CH₃)₃SiO—* |
| (H-I-2) | C₂H₅O—* | *—O—* | CH₃—* | 1~60 | *—Si(CH₃)₂—CH₂—* | (CH₃)₃SiO—* |
| (H-I-3) | C₂H₅O—* | *—O—* | CH₃—* | 1~60 | *—Si(CH₃)₂—(CH₂)₂—* | (CH₃)₃SiO—* |
| (H-I-4) | C₂H₅O—* | *—O—* | CH₃—* | 1~60 | *—Si(CH₃)₂—(CH₂)₃—* | (CH₃)₃SiO—* |
| (H-I-5) | C₂H₅O—* | *—O—* | CH₃—* | 1~60 | *—Si(CH₃)₂—(CH₂)₄—* | (CH₃)₃SiO—* |
| (H-I-6) | C₂H₅O—* | *—CH₂—* | CH₃—* | 1~60 | — | (CH₃)₃SiO—* |
| (H-I-7) | C₂H₅O—* | *—CH₂—* | CH₃—* | 1~60 | *—Si(CH₃)₂—CH₂—* | (CH₃)₃SiO—* |
| (H-I-8) | C₂H₅O—* | *—CH₂—* | CH₃—* | 1~60 | *—Si(CH₃)₂—(CH₂)₂—* | (CH₃)₃SiO—* |
| (H-I-9) | C₂H₅O—* | *—CH₂—* | CH₃—* | 1~60 | *—Si(CH₃)₂—(CH₂)₃—* | (CH₃)₃SiO—* |
| (H-I-10) | C₂H₅O—* | *—CH₂—* | CH₃—* | 1~60 | *—Si(CH₃)₂—(CH₂)₄—* | (CH₃)₃SiO—* |
| (H-I-11) | C₂H₅O—* | *—(CH₂)₂—* | CH₃—* | 1~60 | — | (CH₃)₃SiO—* |
| (H-I-12) | C₂H₅O—* | *—(CH₂)₂—* | CH₃—* | 1~60 | *—Si(CH₃)₂—CH₂—* | (CH₃)₃SiO—* |
| (H-I-13) | C₂H₅O—* | *—(CH₂)₂—* | CH₃—* | 1~60 | *—Si(CH₃)₂—(CH₂)₂—* | (CH₃)₃SiO—* |
| (H-I-14) | C₂H₅O—* | *—(CH₂)₂—* | CH₃—* | 1~60 | *—Si(CH₃)₂—(CH₂)₃—* | (CH₃)₃SiO—* |
| (H-I-15) | C₂H₅O—* | *—(CH₂)₂—* | CH₃—* | 1~60 | *—Si(CH₃)₂—(CH₂)₄—* | (CH₃)₃SiO—* |
| (H-I-16) | C₂H₅O—* | *—(CH₂)₃—* | CH₃—* | 1~60 | — | (CH₃)₃SiO—* |
| (H-I-17) | C₂H₅O—* | *—(CH₂)₃—* | CH₃—* | 1~60 | *—Si(CH₃)₂—CH₂—* | (CH₃)₃SiO—* |
| (H-I-18) | C₂H₅O—* | *—(CH₂)₃—* | CH₃—* | 1~60 | *—Si(CH₃)₂—(CH₂)₂—* | (CH₃)₃SiO—* |
| (H-I-19) | C₂H₅O—* | *—(CH₂)₃—* | CH₃—* | 1~60 | *—Si(CH₃)₂—(CH₂)₃—* | (CH₃)₃SiO—* |
| (H-I-20) | C₂H₅O—* | *—(CH₂)₃—* | CH₃—* | 1~60 | *—Si(CH₃)₂—(CH₂)₄—* | (CH₃)₃SiO—* |
| (H-I-21) | C₂H₅O—* | *—(CH₂)₄—* | CH₃—* | 1~60 | — | (CH₃)₃SiO—* |
| (H-I-22) | C₂H₅O—* | *—(CH₂)₄—* | CH₃—* | 1~60 | *—Si(CH₃)₂—CH₂—* | (CH₃)₃SiO—* |
| (H-I-23) | C₂H₅O—* | *—(CH₂)₄—* | CH₃—* | 1~60 | *—Si(CH₃)₂—(CH₂)₂—* | (CH₃)₃SiO—* |
| (H-I-24) | C₂H₅O—* | *—(CH₂)₄—* | CH₃—* | 1~60 | *—Si(CH₃)₂—(CH₂)₃—* | (CH₃)₃SiO—* |
| (H-I-25) | C₂H₅O—* | *—(CH₂)₄—* | CH₃—* | 1~60 | *—Si(CH₃)₂—(CH₂)₄—* | (CH₃)₃SiO—* |

TABLE 3-2

| | A^{h10} | Z^{s10} | R^{s20} | n10 | Y^{s10} | R^{s10} |
|---|---|---|---|---|---|---|
| (H-I-26) | CH₃O—* | *—O—* | CH₃—* | 1~60 | — | (CH₃)₃SiO—* |
| (H-I-27) | CH₃O—* | *—O—* | CH₃—* | 1~60 | *—Si(CH₃)₂—CH₂—* | (CH₃)₃SiO—* |
| (H-I-28) | CH₃O—* | *—O—* | CH₃—* | 1~60 | *—Si(CH₃)₂—(CH₂)₂—* | (CH₃)₃SiO—* |
| (H-I-29) | CH₃O—* | *—O—* | CH₃—* | 1~60 | *—Si(CH₃)₂—(CH₂)₃—* | (CH₃)₃SiO—* |
| (H-I-30) | CH₃O—* | *—O—* | CH* | 1~60 | *—Si(CH₃)₂—(CH₂)₄—* | (CH₃)₃SiO—* |
| (H-I-31) | CH₃O—* | *—CH₂—* | CH₃—* | 1~60 | — | (CH₃)₃SiO—* |
| (H-I-32) | CH₃O—* | *—CH₂—* | CH₃—* | 1~60 | *—Si(CH₃)₂—CH₂—* | (CH₃)₃SiO—* |
| (H-I-33) | CH₃O—* | *—CH₂—* | CH₃—* | 1~60 | *—Si(CH₃)₂—(CH₂)₂—* | (CH₃)₃SiO—* |
| (H-I-34) | CH₃O—* | *—CH₂—* | CH₃—* | 1~60 | *—Si(CH₃)₂—(CH₂)₃—* | (CH₃)₃SiO—* |
| (H-I-35) | CH₃O—* | *—CH₂—* | CH₃—* | 1~60 | *—Si(CH₃)₂—(CH₂)₄—* | (CH₃)₃SiO—* |
| (H-I-36) | CH₃O—* | *—(CH₂)₂—* | CH₃—* | 1~60 | — | (CH₃)₃SiO—* |
| (H-I-37) | CH₃O—* | *—(CH₂)₂—* | CH₃—* | 1~60 | *—Si(CH₃)₂—CH₂—* | (CH₃)₃SiO—* |
| (H-I-38) | CH₃O—* | *—(CH₂)₂—* | CH₃—* | 1~60 | *—Si(CH₃)₂—(CH₂)₂—* | (CH₃)₃SiO—* |
| (H-I-39) | CH₃O—* | *—(CH₂)₂—* | CH₃—* | 1~60 | *—Si(CH₃)₂—(CH₂)₃—* | (CH₃)₃SiO—* |
| (H-I-40) | CH₃O—* | *—(CH₂)₂—* | CH₃—* | 1~60 | *—Si(CH₃)₂—(CH₂)₄—* | (CH₃)₃SiO—* |
| (H-I-41) | CH₃O—* | *—(CH₂)₃—* | CH₃—* | 1~60 | — | (CH₃)₃SiO—* |
| (H-I-42) | CH₃O—* | *—(CH₂)₃—* | CH₃—* | 1~60 | *—Si(CH₃)₂—CH₂—* | (CH₃)₃SiO—* |
| (H-I-43) | CH₃O—* | *—(CH₂)₃—* | CH₃—* | 1~60 | *—Si(CH₃)₂—(CH₂)₂—* | (CH₃)₃SiO—* |
| (H-I-44) | CH₃O—* | *—(CH₂)₃—* | CH₃—* | 1~60 | *—Si(CH₃)₂—(CH₂)₃—* | (CH₃)₃SiO—* |
| (H-I-45) | CH₃O—* | *—(CH₂)₃—* | CH₃—* | 1~60 | *—Si(CH₃)₂—(CH₂)₄—* | (CH₃)₃SiO—* |
| (H-I-46) | CH₃O—* | *—(CH₂)₄—* | CH₃—* | 1~60 | — | (CH₃)₃SiO—* |
| (H-I-47) | CH₃O—* | *—(CH₂)₄—* | CH₃—* | 1~60 | *—Si(CH₃)₂—CH₂—* | (CH₃)₃SiO—* |
| (H-I-48) | CH₃O—* | *—(CH₂)₄—* | CH₃—* | 1~60 | *—Si(CH₃)₂—(CH₂)₂—* | (CH₃)₃SiO—* |
| (H-I-49) | CH₃O—* | *—(CH₂)₄—* | CH₃—* | 1~60 | *—Si(CH₃)₂—(CH₂)₃—* | (CH₃)₃SiO—* |
| (H-I-50) | CH₃O—* | *—(CH₂)₄—* | CH₃—* | 1,,60 | *—Si(CH₃)₂—(CH₂)₄—* | (CH₃)₃SiO—* |

TABLE 4-1

| | A^{h10} | Z^{s10} | R^{s20} | n10 | Y^{s10} | R^{s10} |
|---|---|---|---|---|---|---|
| (H-I-51) | C₂H₅O—* | *—O—* | CH₃—* | 1~60 | — | CH₃—* |
| (H-I-52) | C₂H₅O—* | *—O—* | CH₃—* | 1~60 | *—Si(CH₃)₂—CH₂—* | CH₃—* |
| (H-I-53) | C₂H₅O—* | *—O—* | CH₃—* | 1~60 | *—Si(CH₃)₂—(CH₂)₂—* | CH₃—* |
| (H-I-54) | C₂H₅O—* | *—O—* | CH₃—* | 1~60 | *—Si(CH₃)₂—(CH₂)₃—* | CH₃—* |
| (H-I-55) | C₂H₅O—* | *—O—* | CH₃—* | 1~60 | *—Si(CH₃)₂—(CH₂)₄—* | CH₃—* |
| (H-I-56) | C₂H₅O—* | *—CH₂—* | CH₃—* | 1~60 | — | CH₃—* |
| (H-I-57) | C₂H₅O—* | *—CH₂—* | CH₃—* | 1~60 | *—Si(CH₃)₂—CH₂—* | CH₃—* |
| (H-I-58) | C₂H₅O—* | *—CH₂—* | CH₃—* | 1~60 | *—Si(CH₃)₂—(CH₂)₂—* | CH₃—* |
| (H-I-59) | C₂H₅O—* | *—CH₂—* | CH₃—* | 1~60 | *—Si(CH₃)₂—(CH₂)₃—* | CH₃—* |
| (H-I-60) | C₂H₅O—* | *—CH₂—* | CH₃—* | 1~60 | *—Si(CH₃)₂—(CH₂)₄—* | CH₃—* |
| (H-I-61) | C₂H₅O—* | *—(CH₂)₂—* | CH₃—* | 1~60 | — | CH₃—* |
| (H-I-62) | C₂H₅O—* | *—(CH₂)₂—* | CH₃—* | 1~60 | *—Si(CH₃)₂—CH₂—* | CH₃—* |
| (H-I-63) | C₂H₅O—* | *—(CH₂)₂—* | CH₃—* | 1~60 | *—Si(CH₃)₂—(CH₂)₂—* | CH₃—* |
| (H-I-64) | C₂H₅O—* | *—(CH₂)₂—* | CH₃—* | 1~60 | *—Si(CH₃)₂—(CH₂)₃—* | CH₃—* |
| (H-I-65) | C₂H₅O—* | *—(CH₂)₂—* | CH₃—* | 1~60 | *—Si(CH₃)₂—(CH₂)₄—* | CH₃—* |
| (H-I-66) | C₂H₅O—* | *—(CH₂)₃—* | CH₃—* | 1~60 | — | CH₃—* |
| (H-I-67) | C₂H₅O—* | *—(CH₂)₃—* | CH₃—* | 1~60 | *—Si(CH₃)₂—CH₂—* | CH₃—* |
| (H-I-68) | C₂H₅O—* | *—(CH₂)₃—* | CH₃—* | 1~60 | *—Si(CH₃)₂—(CH₂)₂—* | CH₃—* |
| (H-I-69) | C₂H₅O—* | *—(CH₂)₃—* | CH₃—* | 1~60 | *—Si(CH₃)₂—(CH₂)₃—* | CH₃—* |
| (H-I-70) | C₂H₅O—* | *—(CH₂)₃—* | CH₃—* | 1~60 | *—Si(CH₃)₂—(CH₂)₄—* | CH₃—* |
| (H-I-71) | C₂H₅O—* | *—(CH₂)₄—* | CH₃—* | 1~60 | — | CH₃—* |
| (H-I-72) | C₂H₅O—* | *—(CH₂)₄—* | CH₃—* | 1~60 | *—Si(CH₃)₂—CH₂—* | CH₃—* |
| (H-I-73) | C₂H₅O—* | *—(CH₂)₄—* | CH₃—* | 1~60 | *—Si(CH₃)₂—(CH₂)₂—* | CH₃—* |
| (H-I-74) | C₂H₅O—* | *—(CH₂)₄—* | CH₃—* | 1~60 | *—Si(CH₃)₂—(CH₂)₃—* | CH₃—* |
| (H-I-75) | C₂H₅O—* | *—(CH₂)₄—* | CH₃—* | 1~60 | *—Si(CH₃)₂—(CH₂)₄—* | CH₃—* |

TABLE 4-2

| | A^{h10} | Z^{s10} | R^{s20} | n10 | Y^{s10} | R^{s10} |
|---|---|---|---|---|---|---|
| (H-I-76) | CH₃O—* | *—O—* | CH₃—* | 1~60 | — | CH₃—* |
| (H-I-77) | CH₃O—* | *—O—* | CH₃—* | 1~60 | *—Si(CH₃)₂—CH₂—* | CH₃—* |
| (H-I-78) | CH₃O—* | *—O—* | CH₃—* | 1~60 | *—Si(CH₃)₂—(CH₂)₂—* | CH₃—* |
| (H-I-79) | CH₃O—* | *—O—* | CH₃—* | 1~60 | *—Si(CH₃)₂—(CH₂)₃—* | CH₃—* |
| (H-I-80) | CH₃O—* | *—O—* | CH₃—* | 1~60 | *—Si(CH₃)₂—(CH₂)₄—* | CH₃—* |
| (H-I-81) | CH₃O—* | *—CH₂—* | CH₃—* | 1~60 | — | CH₃—* |
| (H-I-82) | CH₃O—* | *—CH₂—* | CH₃—* | 1~60 | *—Si(CH₃)₂—CH₂—* | CH₃—* |
| (H-I-83) | CH₃O—* | *—CH₂—* | CH₃—* | 1~60 | *—Si(CH₃)₂—(CH₂)₂—* | CH₃—* |
| (H-I-84) | CH₃O—* | *—CH₂—* | CH₃—* | 1~60 | *—Si(CH₃)₂—(CH₂)₃—* | CH₃—* |
| (H-I-85) | CH₃O—* | *—CH₂—* | CH₃—* | 1~60 | *—Si(CH₃)₂—(CH₂)₄—* | CH₃—* |
| (H-I-86) | CH₃O—* | *—(CH₂)₂—* | CH₃—* | 1~60 | — | CH₃—* |
| (H-I-87) | CH₃O—* | *—(CH₂)₂—* | CH₃—* | 1~60 | *—Si(CH₃)₂—CH₂—* | CH₃—* |
| (H-I-88) | CH₃O—* | *—(CH₂)₂—* | CH₃—* | 1~60 | *—Si(CH₃)₂—(CH₂)₂—* | CH₃—* |
| (H-I-89) | CH₃O—* | *—(CH₂)₂—* | CH₃—* | 1~60 | *—Si(CH₃)₂—(CH₂)₃—* | CH₃—* |
| (H-I-90) | CH₃O—* | *—(CH₂)₂—* | CH₃—* | 1~60 | *—Si(CH₃)₂—(CH₂)₄—* | CH₃—* |
| (H-I-91) | CH₃O—* | *—(CH₂)₃—* | CH₃—* | 1~60 | — | CH₃—* |
| (H-I-92) | CH₃O—* | *—(CH₂)₃—* | CH₃—* | 1~60 | *—Si(CH₃)₂—CH₂—* | CH₃—* |
| (H-I-93) | CH₃O—* | *—(CH₂)₃—* | CH₃—* | 1~60 | *—Si(CH₃)₂—(CH₂)₂—* | CH₃—* |
| (H-I-94) | CH₃O—* | *—(CH₂)₃—* | CH₃—* | 1~60 | *—Si(CH₃)₂—(CH₂)₃—* | CH₃—* |
| (H-I-95) | CH₃O—* | *—(CH₂)₃—* | CH₃—* | 1~60 | *—Si(CH₃)₂—(CH₂)₄—* | CH₃—* |
| (H-I-96) | CH₃O—* | *—(CH₂)₄—* | CH₃—* | 1~60 | — | CH₃—* |
| (H-I-97) | CH₃O—* | *—(CH₂)₄—* | CH₃—* | 1~60 | *—Si(CH₃)₂—CH₂—* | CH₃—* |
| (H-I-98) | CH₃O—* | *—(CH₂)₄—* | CH₃—* | 1~60 | *—Si(CH₃)₂—(CH₂)₂—* | CH₃—* |
| (H-I-99) | CH₃O—* | *—(CH₂)₄—* | CH₃—* | 1~60 | *—Si(CH₃)₂—(CH₂)₃—* | CH₃—* |
| (H-I-100) | CH₃O—* | *—(CH₂)₄—* | CH₃—* | 1~60 | *—Si(CH₃)₂—(CH₂)₄—* | CH₃—* |

As the compound (H) including a siloxane chain, compounds represented by the following formulas (H3) and (H4) are more preferable.

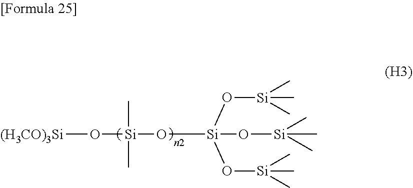

In formula (H3), n2 is an integer of 1 to 60.

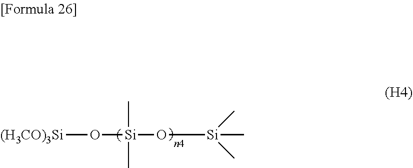

In formula (H4), n4 is an integer of 1 to 60.

It is more preferable that n2 and n4 are integers of 2 or more, and further preferably integers of 3 or more, and more preferably integers of 50 or less, further preferably integers of 45 or less, still further preferably integers of 30 or less, and particularly preferably integers of 25 or less.

The number average molecular weight (Mn) of the compound (H) including a siloxane chain is preferably 300 or more, more preferably 350 or more, and further preferably 400 or more, and is preferably 5200 or less, more preferably 4000 or less, further preferably 3500 or less, still further preferably 3200 or less, particularly preferably 3000 or less, and most preferably 2500 or less.

The number average molecular weight (Mn) can be measured under the following conditions using, for example, gel permeation chromatography (GPC). As a pretreatment, as a measurement solution, it is preferable to use a solution that was dissolved in an eluent and then filtered through a 0.45 μm membrane filter.

### [Measurement Conditions]

Apparatus: Shimadzu LC-10
Column: OligoPore, PLgel MIXED-D
Eluent: toluene
Flow rate: 1.0 mL/min
Detector: RI detector
Column temperature: 35° C.
Injection amount: 50 μL
Molecular weight standards: Standard polystyrene 110,000, 100,000, 43000, 38000, 6000, 2600, and 600

The amount of the compound (H) including a siloxane chain is, based on the whole composition of 100% by mass, preferably 0.005% by mass or more, more preferably 0.01% by mass or more, and further preferably 0.03% by mass or more, and is preferably 1.0% by mass or less, more preferably 0.5% by mass or less, further preferably less than 0.3% by mass, still further preferably 0.2% by mass or less, and particularly preferably 0.15% by mass or less.

The amount of the compound (H) including a siloxane chain can be adjusted at the time of preparation of the composition. The amount of the compound (H) including a siloxane chain may be calculated from an analysis result of the composition. It is noted that in the present specification, when referring to the ranges of the amount or mass ratio of each component, as described above, those ranges can be adjusted at the time of preparation of the composition.

By using a predetermined amount of the compound (H) including a siloxane chain in the composition of the present invention, coatability when the composition is brought into contact with the base material is improved.

Examples of the method for synthesizing the compound (H) including a siloxane chain include the methods described in Japanese Patent Laid-Open No. 2017-201009.

### 3. Metal Compound (G)

The metal compound (G) of the present invention is at least one selected from a metal compound represented by the following formula (G1) and a condensate thereof.

M(R^{g10})ᵣ(A^{g1})ₘ₋ᵣ (G1)

In formula (G1), M represents Al, Fe, In, Ge, Hf, Si, Ti, Sn, Zr, or Ta. R^{g10} represents a hydrocarbon chain-containing group or a hydrogen atom, and r is 0 or 1. A plurality of A^{g1} each independently represent a hydrolyzable group, and m is an integer of 3 to 5 in accordance with the metal atom M.

The metal compound (G) represented by formula (G1) is a compound in which at least a hydrolyzable group A^{g1} is bonded to the metal atom M. In this specification, the meaning of “metal” includes semimetals such as Si and Ge.

The metal atom M is preferably Al, Si, Ti, Sn, or Zr, more preferably Al, Si, Ti, or Zr, and further preferably Si.

The hydrolyzable group represented by A^{g1} may be any group that gives a hydroxy group (silanol group etc.) by hydrolysis. Preferable examples thereof include an alkoxy group having 1 to 6 carbon atoms, such as a methoxy group, an ethoxy group, a propoxy group, and a butoxy group; a hydroxy group; an acetoxy group; a chlorine atom; an isocyanate group; and the like. Among these, an alkoxy group having 1 to 6 carbon atoms is preferable, an alkoxy group having 1 to 4 carbon atoms is more preferable, and an alkoxy group having 1 to 2 carbon atoms is further preferable.

The hydrocarbon chain-containing group represented by R^{g10} means a group having a hydrocarbon group in at least a portion thereof. Usually, the hydrocarbon chain-containing group is composed of only hydrocarbon groups (hydrocarbon chains), but if necessary, the hydrocarbon chain-containing group may be a group in which some of the methylene groups (—CH₂—) of the hydrocarbon chain are replaced by oxygen atoms. Further, a methylene group (—CH₂—) adjacent to the metal atom M is not replaced by an oxygen atom, and two consecutive methylene groups (—CH₂—) are not replaced by oxygen atoms at the same time.

The number of carbon atoms of the hydrocarbon chain-containing group means, for a non-oxygen-substituted hydrocarbon chain-containing group, the number of carbon atoms constituting the hydrocarbon group (hydrocarbon chain), and for an oxygen-substituted hydrocarbon chain-containing group, the number of carbon atoms constituting the hydrocarbon group (hydrocarbon chain) counted by assuming that the oxygen atoms are a methylene group (—CH₂—).

Hereinafter, unless otherwise specified, the hydrocarbon chain-containing group is described based on the example of a non-oxygen-substituted hydrocarbon chain-containing group (that is, a monovalent hydrocarbon group) as an example, but in the entire description below, it is possible to replace some of the methylene groups (—CH₂—) constituting the hydrocarbon chain-containing group by oxygen atoms.

When the hydrocarbon chain-containing group is a hydrocarbon group, the hydrocarbon chain-containing group preferably has 1 or more and 18 or less carbon atoms, more preferably 1 or more and 10 or less carbon atoms, further preferably 1 or more and 6 or less carbon atoms, and still further preferably 1 carbon atom. Further, the hydrocarbon chain-containing group may be a branched chain or a straight chain. The hydrocarbon chain-containing group is preferably a saturated or unsaturated aliphatic hydrocarbon chain-containing group, and more preferably a saturated aliphatic hydrocarbon chain-containing group. As the saturated aliphatic hydrocarbon chain-containing group, a saturated aliphatic hydrocarbon group is more preferable. Examples of the saturated aliphatic hydrocarbon group include a methyl group, an ethyl group, a propyl group, and the like.

When some of the methylene groups (—CH₂—) of the saturated aliphatic hydrocarbon group are replaced by an oxygen atom, specific examples include a group having a (poly)ethylene glycol unit.

Here, “m” is the valence of the metal atom M so when the metal atom M is a trivalent metal such as Al, Fe, or In, m is 3, when the metal atom M is a tetravalent metal such as Ge, Hf, Si, Ti, Sn, or Zr, m is 4, and when the metal atom M is a pentavalent metal such as Ta, m is 5.

Examples of the metal compound represented by formula (G1) include: a metal compound G11 in which r=0, that is, only a hydrolyzable group A^{g1} is bonded to the metal atom M; and a metal compound G12 in which r=1, that is, one hydrocarbon chain-containing group or hydrogen atom and two or more hydrolyzable groups A^{g1} are bonded to the metal atom M.

3.1 Metal compound G11

Specific examples of the metal compound G11 in which only a hydrolyzable group A^{g1} is bonded to the metal atom M include: trialkoxyaluminum, such as triethoxyaluminum, tripropoxyaluminum, and tributoxyaluminum; trialkoxyiron, such as triethoxyiron; trialkoxyindium, such as trimethoxyindium, triethoxyindium, tripropoxyindium, and tributoxyindium; tetraalkoxygermanium, such as tetramethoxygermanium, tetraethoxygermanium, tetrapropoxygermanium, and tetrabutoxygermanium; tetraalkoxyhafnium, such as tetramethoxyhafnium, tetraethoxyhafnium, tetrapropoxyhafnium, and tetrabutoxyhafnium; tetraalkoxysilanes, such as tetramethoxysilane, tetraethoxysilane, tetrapropoxysilane, and tetrabutoxysilane; tetraalkoxytitanium, such as tetramethoxytitanium, tetraethoxytitanium, tetrapropoxytitanium, and tetrabutoxytitanium; tetraalkoxytin, such as tetramethoxytin, tetraethoxytin, tetrapropoxytin, and tetrabutoxytin; tetraalkoxyzirconium, such as tetramethoxyzirconium, tetraethoxyzirconium, tetrapropoxyzirconium, and tetrabutoxyzirconium; penta-alkoxytantalum such as pentamethoxytantalum, pentaethoxytantalum, pentapropoxytantalum, pentabutoxytantalum; and the like.

3.2 Metal compound G12

The metal compound G12, in which one hydrocarbon chain-containing group or hydrogen atom and two or more hydrolyzable groups A^{g1} are bonded to the metal atom M, is preferably a metal compound in which the metal atom M is a tetravalent metal (Ge, Hf, Si, Ti, Sn, Zr, etc.), and more preferably a metal compound in which the metal atom M is Si. Specific examples when the metal atom M is Si include: alkyltrialkoxysilanes, such as methyltrimethoxysilane, ethyltrimethoxysilane, methyltriethoxysilane, ethyltriethoxysilane, and methyltripropoxysilane; alkenyltrialkoxysilanes, such as vinyltrimethoxysilane and vinyltriethoxysilane; trialkoxysilanes, such as trimethoxysilane, triethoxysilane and tripropoxysilane; dialkoxyalkylsilanes such as dimethoxymethylsilane and diethoxymethylsilane; and the like.

Specifically, as the metal compound (G1), a compound represented by the following formula (G2) is preferable.

Si(OR^{g21})_{y}(R^{g22})_{4-y} (G2)

In formula (G2) , R^{g21} represents an alkyl group having 1 to 6 carbon atoms, R^{g22} represents a hydrocarbon chain-containing group or a hydrogen atom, and y is 3 or 4.

The number of carbon atoms of the alkyl group represented by R^{g21} is preferably 1 to 4, more preferably 1 to 3, and further preferably 1 or 2.

Examples of the alkyl group represented by R^{g21} include a methyl group, an ethyl group, a propyl group, a butyl group, a pentyl group, a hexyl group, and the like.

Examples of the hydrocarbon chain-containing group represented by R^{g22} include the same groups as those described for the hydrocarbon chain-containing group represented by R^{g10}, and the preferred range is also the same.

Examples of condensates of the metal compound represented by formula (G1) include compounds formed by, for example, hydrolyzing and condensing the hydrolyzable groups of a plurality of metal compounds represented by formula (G1). The plurality of metal compounds represented by formula (G1) may be the same or different, but are preferably the same. A condensate of 2 to 60 metal compounds represented by formula (G1) is preferable, more preferably a compound of 2 to 40 metal compounds condensed, further preferably a condensate of 2 to 20 metal compounds, and still further preferably a condensate of 2 to 10 metal compounds. The metal compounds represented by formula (G1) may be hydrolyzed and condensed to obtain a condensate, or a commercially available siloxane oligomer or resin may be used as appropriate.

The metal compound (G) is preferably at least one selected from a compound represented by formula (G2) and a condensate thereof.

The condensate of the compound represented by formula (G2) is preferably a compound formed by hydrolyzing and condensing the (OR^{g21}) groups of a plurality of metal compounds represented by formula (G2). The plurality of metal compounds represented by formula (G2) may be the same or different, but are preferably the same. The condensate of the compounds represented by formula (G2) is preferably a condensate of 2 to 60 metal compounds represented by formula (G2), more preferably a compound of 2 to 40 metal compounds condensed, further preferably a condensate of 2 to 20 metal compounds, and still further preferably a condensate of 2 to 10 metal compounds. The condensate of the compound represented by formula (G2) is preferably a condensate of a tetraalkoxysilane, more preferably a condensate of tetramethoxysilane or tetraethoxysilane, and particularly preferably a condensate of tetraethoxysilane. Specific examples of the condensate of the compound represented by formula (G2) include ethyl silicate 40, ethyl silicate 48, methyl silicate 51, and methyl silicate 53A, which are manufactured by Colcote Co., Ltd.

Further, two or more types of the metal compound (G) may be used.

The amount of the metal compound (G) is, based on the whole composition of 100% by mass, preferably 0.01% by mass or more, more preferably 0.05% by mass or more, further preferably 0.1% by mass or more, and still further preferably 0.15% by mass or more, and is preferably 10% by mass or less, more preferably 3% by mass or less, further preferably 1% by mass or less, and still further preferably 0.8% by mass or less.

The total amount of the polysilazane (F), the compound (H) including a siloxane chain, and the metal compound (G) is, based on the whole composition of 100% by mass, preferably 0.3% by mass or more, more preferably 0.4% by mass or more, and further preferably 0.5% by mass or more, and is preferably 5% by mass or less, more preferably 3% by mass or less, further preferably less than 2.6% by mass, still further preferably 1.5% by mass or less, and particularly preferably 1.2% by mass or less.

The mass ratio ((H+G)/(F+H+G)) of the compound (H) including a siloxane chain and metal compound (G) to the total amount of the polysilazane (F), the compound (H) including a siloxane chain, and the metal compound (G) is preferably 1% or more, more preferably 5% or more, and further preferably 8% or more, and is preferably 95% or less, more preferably 85% or less, further preferably 80% or less, still further preferably 70% or less, and particularly preferably 60% or less. If the mass ratio is too small, appearance defects may occur, and if the mass ratio is too large, it may not be possible to impart excellent curability to the liquid-repellent layer.

The mixed composition of the present invention is a composition in which the above-described polysilazane (F), compound (H) including a siloxane chain, and metal compound (G) are mixed, and is obtained by mixing these (F) to (H).

### 4. Solvent (I)

A solvent (I) may be used in the composition of the present invention.

Examples of the solvent (I) include alcohol solvents, ether solvents, ketone solvents, ester solvents, amide solvents, aliphatic hydrocarbon solvents, aromatic hydrocarbon solvents, and the like.

Examples of the alcohol solvent include methanol, ethanol, propanol, 2-propanol, butanol, ethylene glycol, propylene glycol, diethylene glycol, 1-propoxy-2-propanol, and the like. Examples of the ether solvent include dimethoxyethane, tetrahydrofuran, dioxane, dibutyl ether, and the like. Examples of the ketone solvent include acetone and methyl ethyl ketone (2-butanone), and the like. Examples of the ester solvent include ethyl acetate, butyl acetate, and the like. Examples of the amide solvent include dimethylformamide and the like. Examples of the aliphatic hydrocarbon solvent include pentane, hexane, heptane, octane, isooctane, cyclopentane, cyclohexane, cycloheptane, methylcyclohexane and mineral spirits, and the like. Examples of the aromatic hydrocarbon solvent include benzene, toluene, xylene, chlorobenzene, dichlorobenzene, and the like. Among these, a ketone solvent, an ether solvent, an ester solvent, and an aliphatic hydrocarbon solvent are preferable, and an aliphatic hydrocarbon solvent is more preferable. One kind of these solvents may be used, or two or more kinds may be appropriately mixed and used. It is preferable that the solvent (I) does not contain moisture, because this allows the stability of the coating liquid to be increased, coating streakiness to be reduced, and foreign matter during coating to be reduced.

The amount of the solvent (I) based on the whole composition of 100% by mass is preferably 50% by mass or more, more preferably 80% by mass or more, further preferably 90% by mass or more, and particularly preferably 95% by mass or more. The upper limit is set according to the amounts of the polysilazane (F), the compound (H) including a siloxane chain, the metal compound (G), and added components other than these (hereinafter referred to as “third component”). A component other than the polysilazane (F), compound (H) including a siloxane chain, metal compound (G), and third component may be the solvent (I).

The mixed composition of the present invention is preferably obtained by also mixing the solvent (I) in addition to the polysilazane (F), the compound (H) including a siloxane chain, and the metal compound (G).

A catalyst may coexist when adjusting the mixed composition of the present invention. In the present invention, the catalyst is preferably a catalyst capable of curing polysilazane. Examples include N-heterocyclic compounds such as 1-methylpiperazine, 1-methylpiperidine, 4,4′-trimethylenedipiperidine, 4,4′-trymethylenebis(1-methylpiperidine), diazabicyclo-[2,2,2]octane, cis-2,6-dimethylpiperazine, 4-(4-methylpiperidine)pyridine, pyridine, dipyridine, α-picoline, β-picoline, γ-picoline, piperidine, lutidine, pyrimidine, pyridazine, 4,4′-trymethylenedipyridine, 2-(methylamino)pyridine, pyrazine, quinoline, quinoxaline, triazine, pyrrole, 3-pyrroline, imidazole, triazole, tetrazole, and 1-methylpyrrolidine, amines such as methylamine, dimethylamine, trimethylamine, ethylamine, diethylamine, triethylamine, propylamine, dipropylamine, tripropylamine, butylamine, dibutylamine, tributylamine, pentylamine, dipentylamine, tripentylamine, hexylamine, dihexylamine, trihexylamine, heptylamine, diheptylamine, octylamine, dioctylamine, trioctylamine, phenylamine, diphenylamine, and triphenylamine, 1,8-diazabicyclo[5,4,0]7-undecene (DBU), 1,5-diazabicyclo[4,3,0]-5-nonene (DBN), 1,5,9-triazacyclododecane, 1,4,7-triazacyclononane, and the like.

Further, as the catalyst, in addition to the above catalysts, a catalyst that acts as a hydrolysis/condensation catalyst of a hydrolyzable group bonded to a silicon atom is also preferable. Examples of such a catalyst include: acidic compounds; basic compounds; organometallic compounds; and the like. Examples of the acidic compound include inorganic acids such as hydrochloric acid, nitric acid, sulfuric acid, phosphoric acid, hydrogen peroxide, chloric acid, and hypochloric acid; and organic acids such as acetic acid, propionic acid, butyric acid, valeric acid, maleic acid and stearic acid. Examples of the basic compound include ammonia and the like. Examples of the organometallic compound include organometallic compounds having a metal element such as Al, Fe, Zn, and Sn as a central metal, such as: organoaluminum compounds such as aluminum carboxylate, an aluminum acetylacetone complex, and an aluminum ethylacetacetate complex; organoiron compounds such as iron carboxylate (iron octylate, etc.); organozinc compounds such as zinc acetylacetonate monohydrate, zinc naphthenate, and zinc octylate; organotin compounds such as a dibutyltin diacetate complex; other organometallic compounds such as metal carboxylates including Ni, Ti, Pt, Rh, Co, Ru, Os, Pd, Ir, and the like; acetylacetonate complexes including Ni, Pt, Pd, Rh, and the like; metal fine particles of Au, Ag, Pd, Ni, Zn, Ti, and the like; metal peroxides; metal chlorides; cyclopentadienyl complexes of metals such as ferrocene and zirconosen; and the like.

The composition of the present invention may coexist with, within a range that does not harm its effects, various additives such as an antioxidant, a rust preventive, an ultraviolet absorber, a light stabilizer, a fungicide, an antibacterial agent, a biofouling inhibitor, a deodorant, a pigment, a flame retardant, and an antistatic agent.

The coating film obtained from the composition of the present invention is generally formed on a substrate. Examples of the method of bringing into contact with the base material include a method of coating the composition onto the base material, such as a spin coating method, a dip coating method, a spray coating method, a roll coating method, a bar coating method, applying by hand (method in which a liquid is impregnated into a cloth and applied onto the base material), pouring (method in which a liquid is applied as is onto the base material using a dropper or the like), and a spraying method (method in which a spray is used to apply onto the base material). In particular, from the viewpoint of workability, a spray coating method, applying by hand, pouring, and a spin coating method are preferable, and pouring and spin coating are more preferable.

When the composition brought into contact with the base material in the manner described above is allowed to stand in the air at room temperature, it reacts with the moisture in the air, and decomposition and siloxy group formation proceed, thereby enabling a coating film containing a Si-O skeleton to be formed on the base material. The standing time is not particularly limited, but is preferably 1 minute or more, and more preferably 2 minutes or more. From the viewpoint of practicality, the standing time is preferably 12 hours or less, more preferably 1 hour or less, further preferably 30 minutes or less, and still further preferably 10 minutes or less.

The film thickness of the coating film can be, for example, about 0.1 to 200 nm. Preferably, the film thickness is 0.2 to 100 nm, and more preferably 0.3 to 50 nm.

The base material that the composition of the present invention is brought into contact with is not particularly limited, and the shape of the base material may be a flat surface, a curved surface, or a three-dimensional structure in which a number of surfaces are combined.

The material of the base material is also not limited, and may be composed of either an organic material or an inorganic material. Examples of organic materials include thermoplastic resins such as acrylic resin, polycarbonate resin, polyester resin, styrene resin, acrylic-styrene copolymer resin, cellulose resin, and polyolefin resin; thermosetting resins such as phenol resin, urea resin, melamine resin, epoxy resin, unsaturated polyester, silicone resin, and urethane resin; and the like. Examples of inorganic materials include ceramics; glass; metals such as iron, silicon, copper, zinc, and aluminum; alloys that include the above metals; and the like.

The base material may be subjected to an easy-adhesion treatment in advance. Examples of the easy-adhesion treatment include hydrophilic treatments such as a corona treatment, a plasma treatment, and an ultraviolet treatment. Further, the base material may also be subjected to a primer treatment with a resin, a silane coupling agent, tetraalkoxysilane, or the like, or a glass coating film of polysilazane or the like may be applied to the base material in advance.

It is preferable to further form a liquid-repellent layer on the surface of the coating film obtained from the composition of the present invention. That is, it is preferable to form on the base material an intermediate layer obtained from the composition of the present invention (hereinafter, sometimes referred to as “composition for forming an intermediate layer”), and to then form the liquid-repellent layer on the surface of the intermediate layer (the surface opposite to the base material). Although the details of the mechanism are unknown, by using the composition of the present invention as the composition for forming an intermediate layer between the liquid-repellent layer and the base material, due to the influence of the product by the hydrolysis condensation reaction of the composition for forming an intermediate layer or the like, there is a high likelihood that the dehydration condensation reaction of the silanol groups in the liquid-repellent layer is promoted as compared with the case where only a liquid-repellent layer is formed on the base material. In that case, by using the composition of the present invention as the composition for forming an intermediate layer, the crosslinking density of the liquid repellent layer is increased, and the wear resistance is significantly improved. In addition, conventionally, heating was required when forming the liquid-repellent layer at a practical speed, but by using the composition of the present invention as the composition for forming an intermediate layer between the liquid-repellent layer and the base material, the liquid-repellent layer can be cured at room temperature at a practical speed.

The liquid-repellent layer (liquid-repellent film) will now be described.

The composition used to obtain the liquid-repellent film (hereinafter, sometimes referred to as “composition for forming a liquid-repellent layer”) preferably mixes an organosilicon compound (A) in which at least one trialkylsilyl group-containing molecular chain and at least one hydrolyzable group are bonded to a silicon atom (hereinafter, sometimes referred to as “central silicon atom”) and a metal compound (B).

### 1. Organosilicon Compound (A)

As the organosilicon compound (A), it is preferable to use a compound in which x in formula (H1) described for the compound (H) including a siloxane chain is 0 or 1. As a result of the trialkylsilyl-containing group bonding to the molecular chain, the water and oil repellency, sulfuric acid resistance, and warm water resistance of the coating film formed from the composition for forming a liquid-repellent layer are improved, and droplets move more easily. Even when the alkyl group of the trialkylsilyl-containing group is replaced by a fluoroalkyl group, the liquid repellency (water repellency and/or oil repellency; hereinafter, sometimes referred to as “water and oil repellency”) of the coating film interface can be similarly improved.

The organosilicon compound (A) is the same as the mode described above for the compound (H) including a siloxane chain, and the preferred range is also the same. Among them, the compound represented by the following formula (H3) is particularly preferable.

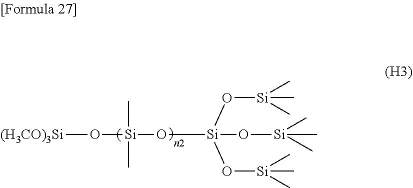

In formula (H3), n2 is an integer of 1 to 60.

n2 is more preferably an integer of 2 or more, and further preferably an integer of 3 or more, and is more preferably an integer of 45 or less, further preferably an integer of 30 or less, and particularly preferably an integer of 25 or less.

The amount of the organosilicon compound (A) is, based on the whole composition for forming a liquid-repellent liquid of 100% by mass, preferably 0.005 to 10% by mass, more preferably 0.01 to 5% by mass, and further preferably 0.01 to 1% by mass.

### 2. Metal Compound (B)

The metal compound (B) is preferably a compound represented by the following formula (b1).

M(R^{b10})ᵣ(A^{b1})ₘ₋ᵣ (b1)

In formula (b1), M represents Al, Fe, In, Ge, Hf, Si, Ti, Sn, Zr, or Ta, R^{b10} represents a siloxane skeleton-containing group, a hydrocarbon chain-containing group, or a hydrogen atom, r is 0 or 1, a plurality of A^{b1} each independently represent a hydrolyzable group, and m is an integer of 3 to 5 in accordance with the metal atom M.

A preferred metal compound (B) is, as represented by formula (b1), a compound in which at least a hydrolyzable group A^{b1} is bonded to the metal atom M. In the present specification, the term “metal” is used in a sense that includes semimetals such as Si and Ge.

As described above, a liquid-repellent film obtained from the composition for forming a liquid-repellent layer has higher water-repellency and oil-repellency due to the trialkylsilyl group derived from the organosilicon compound (A), and it is considered that the structure based on the metal compound (B) functions as a spacer in the liquid-repellent film.

M is preferably Al, Si, Ti, Sn, or Zr, and more preferably Si.

The hydrolyzable group represented by A^{b1} and the siloxane skeleton-containing group or hydrocarbon chain-containing group represented by R^{b1} can be appropriately selected from the hydrolyzable groups, siloxane skeleton-containing groups, and hydrocarbon chain-containing groups described for the compound (H) including a siloxane chain, and the preferred ranges thereof are also the same.

Here, “m” is the valence of the metal atom M, so when the metal atom M is a trivalent metal such as Al, Fe, or In, m is 3, when the metal atom M is a tetravalent metal such as Ge, Hf, Si, Ti, Sn, or Zr, m is 4, and when the metal atom M is a pentavalent metal such as Ta, m is 5.

The composition for forming a liquid-repellent layer may use two or more types of the metal compound (B). Further, a condensate of the metal compound (B) may be used.

Specifically, as the metal compound (B), a compound represented by the following formula (b2) is preferable.

Si(OR^{b11})_{z}H_{4-z} (b2)

In formula (b2) , R^{b11} represents an alkyl group having 1 to 6 carbon atoms, and z is 3 or 4.

The number of carbon atoms of the alkyl group represented by R^{b11} is preferably 1 to 4, and more preferably 1 or 2.

Examples of the alkyl group represented by R^{b11} include a methyl group, an ethyl group, a propyl group, a butyl group, and the like.

The amount of the metal compound (B) is, based on the whole composition for forming a liquid-repellent layer of 100% by mass, preferably 0.01 to 50% by mass, more preferably 0.05 to 10% by mass, and further preferably 0.05 to 1% by mass.

The composition for forming a liquid-repellent layer is a composition in which the organosilicon compound (A) and the metal compound (B) are mixed, and can be obtained by mixing (A) and (B).

### 3. Catalyst (C)

When preparing the composition for forming a liquid-repellent layer, a catalyst (C) that acts as a hydrolyzing/condensing catalyst of hydrolyzable groups bonded to the silicon atom may be made to coexist with the organosilicon compound (A) and the metal compound (B). As the catalyst (C), an acid, an alkali, or the like can be used, and among them it is preferable to use an acid. The acid may be an inorganic acid or an organic acid, and it is particularly preferable to use an organic acid from the viewpoint of ease of control of hydrolysis/condensation reaction. By using an acid as the catalyst (C) and suppressing the amount of water used in the manner described later, the reaction at the time of forming the liquid-repellent film can be made to proceed in a moderate manner, and a good liquid-repellent film can be formed.

Specific examples of the acid include nitric acid, hydrochloric acid, maleic acid, phosphoric acid, malonic acid, formic acid, benzoic acid, phenylethaneic acid, acetic acid, butanoic acid, 2-methylpropanoic acid, propanoic acid, 2,2-dimethylpropanoic acid, and the like. Preferably, the acid is an organic acid, and more preferably is maleic acid (pKa=1.92), formic acid (pKa=3.75), or acetic acid (pKa=4.76).

One type of the catalyst (C) may be used or two or more types may be used in combination.

The amount of the catalyst (C) is, based on the whole composition for forming a liquid-repellent layer of 100% by mass, preferably 0.0001 to 30% by mass, and more preferably 0.00015 to 1% by mass.

### 4. Water (D)

Water (D) is preferably used in the composition for forming a liquid-repellent layer. By using the water (D), the hydrolysis of hydrolyzable groups is promoted. The water (D) may be moisture in the air, or may be proactively mixed into the composition by adding water.

The amount of the water (D) used in adjusting the composition for forming a liquid-repellent layer is preferably more than 0% by mass and less than 2.20% by mass. By setting the amount of the water to less than 2.20% by mass, the reaction at the time of forming the liquid-repellent film can be made to proceed in a moderate manner, and a good liquid-repellent film can be formed.

### 5. Solvent (E)

A solvent (E) may be further used in the composition for forming a liquid-repellent layer. Examples of the solvent (E) include the same solvents described above as examples of the solvent (I). Among them, an alcohol solvent or an ether solvent is preferable, and an alcohol solvent is more preferable.

The amount of the solvent (E) is, based on the whole composition for forming a liquid-repellent layer of 100% by mass, preferably 10 to 99.9% by mass.

The composition for forming a liquid-repellent layer is preferably obtained by mixing, in addition to the above-described organosilicon compound (A) and metal compound (B), the catalyst (C), the water (D), the solvent (E), and the like.

The composition for forming a liquid-repellent layer may coexist with, within a range that does not harm the effect of the present invention, for example, various additives such as an antioxidant, a rust preventive, an ultraviolet absorber, a light stabilizer, a fungicide, an antibacterial agent, a biofouling inhibitor, a deodorant, a pigment, a flame retardant, and an antistatic agent.

A liquid-repellent film can be obtained by curing the composition for forming a liquid-repellent layer.

The method of bringing the composition for forming a liquid-repellent layer into contact with the coating film (intermediate layer) obtained from the composition of the present invention is the same as the method described for the method of bringing the intermediate layer into contact with the base material.

By heating (for example, at 80 to 300° C.) for about 1 to 10 hours in a state in which the composition for forming a liquid-repellent layer is in contact with the intermediate layer, hydrolysis of the hydrolyzable groups of the liquid-repellent layer and a dehydration condensation reaction of the silanol groups are promoted, enabling a liquid-repellent layer to be formed on the intermediate layer. However, when using the composition of the present invention as the composition for forming an intermediate layer, the dehydration condensation reaction of the silanol groups in the liquid repellent layer may be promoted even without heating due to the influence of products formed by the hydrolysis condensation reaction of the composition for forming an intermediate layer or the like. That is, by using the composition of the present invention as the composition for forming an intermediate layer, it is possible to form a liquid-repellent film at a practical speed by allowing the composition for forming an intermediate layer to stand in air at normal temperature and humidity. The standing time is not particularly limited, but is preferably 1 hour or longer, more preferably 3 hours or longer, and further preferably 12 hours or longer. Further, from the viewpoint of practicality, it is preferably 48 hours or less, and more preferably 24 hours or less.

The film thickness of the liquid repellent film can be, for example, about 0.5 to 100 nm.

### EXAMPLES

Hereinafter, the present invention will be described in more detail with reference to Examples, but the present invention is not limited by the following Examples. Modifications may be appropriately made to the present invention without departing from the gist described above and below, and all of such modifications are within the technical scope of the invention.

### Production example 1

### (Production of Composition for Forming Water-Repellent Layer)

A sample solution 1 was obtained by dissolving 0.014 parts by mass of a compound having an average of n2 of 24 in the compound represented by formula (H3) (hereinafter, referred to as “compound 1”) and 0.036 parts by mass of triethoxysilane in 0.1027 parts by mass of 2-propanol, stirring the resultant solution at room temperature for 10 minutes, then adding 0.1 M aqueous acetic acid solution (acetic acid: 7.73×10⁻³ parts by mass, water: 0.013 parts by mass) dropwise to the solution, and stirring the mixture at 65° C. for 2 hours.

The obtained sample solution 1 was diluted with 46.7 parts by mass of 2-propanol to prepare composition A.

Compositions B and composition C were obtained in the same manner as composition A, except that the types and/or amounts of the organosilicon compound (A), the metal compound (B), the catalyst (C), the water (D), and the solvent (E) were changed as shown in Table 5.

TABLE 5

| | | | Composition | Composition | Composition |
|---|---|---|---|---|---|
| | | | A | B | C |
| Organosilicon | Compound 1 | parts by mass | 0.014 | 0.011 | 0.014 |
| compound (A) | | % by mass | 0.029 | 0.023 | 0.029 |
| Metal compound | Triethoxysilane | parts by mass | 0.036 | | 0.036 |
| (B) | | % by mass | 0.077 | | 0.076 |
| | Tetraethoxysilane | parts by mass | | 0.036 | |
| | | % by mass | | 0.077 | |
| Catalyst (C) | Acetic acid | parts by mass | 7.73 × 10⁻⁵ | | 7.73 × 10⁻⁵ |
| | | % by mass | 1.65 × 10⁻⁴ | | 1.64 × 10⁻⁴ |
| | Maleic acid | parts by mass | | 2.5 × 10⁻³ | |
| | | % by mass | | 5.41 × 10⁻³ | |
| Water (D) | | parts by mass | 0.013 | 0.010 | 0.383 |
| | | % by mass | 0.027 | 0.022 | 0.811 |
| Solvent (E) | 2-propanol | parts by mass | 46.81 | 46.81 | 46.81 |
| | | % by mass | 99.87 | 99.87 | 99.08 |

### (Production of Composition for Forming an Intermediate Layer)

A composition for forming an intermediate layer (composition 1) was obtained by dissolving 0.15 parts by mass of Durazane (registered trademark) 1500 rapid cure (manufactured by MERCK), 0.015 parts by mass of the compound (1), 0.09 parts by mass of tetraethoxysilane in 29.75 parts by mass of isooctane. The Durazane (registered trademark) 1500 rapid cure has a structural unit represented by the following formula (f4).

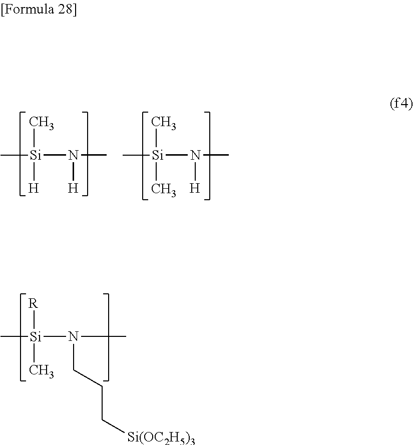

In formula (f4), R represents a hydrogen atom or a methyl group.

Durazane (registered trademark) 1500 rapid cure has a Si(OC₂H₅)₃ group content of 9 to 27% by mass. Further, the molar ratio (methyl group/hydrogen atom) of the hydrogen atoms of the SiH groups to the methyl groups of the Si—CH₃ groups in the structure in (f4) was 2.39.

The mass ratio of the Si(OC₂H₅)₃ groups and the molar ratio of the hydrogen atoms to the methyl groups were determined based on the integrated value of ¹H-NMR (400 MHz, reference: CDCl₃ (=7.24 ppm)). That is, the molar ratios of the SiH, SiCH₃, and Si (OCH₂CH₃)₃ in the polysilazane were obtained from the integrated values, and the molar ratios of the hydrogen atoms and the methyl groups were calculated. Moreover, each molar ratio was converted into a mass ratio, and the % by mass of the Si(OC₂H₅)₃ groups included in the polysilazane was calculated.

Compositions 2 to 13 were obtained in the same manner as composition 1, except that the types and/or amounts of the polysilazane (F), compound (H) including a siloxane chain, metal compound (G), and solvent (I) were changed to those shown in Table 6.

TABLE 6

| | | | | Compo- | Compo- | Compo- | Compo- | Compo- | Compo- | Compo- |
|---|---|---|---|---|---|---|---|---|---|---|
| | | | | sition 1 | sition 2 | sition 3 | sition 4 | sition 5 | sition 6 | sition 7 |
| Component | Polysiloxane (F) | | parts by mass | 0.150 | 0.150 | 0.150 | 0.150 | 0.100 | 0.200 | 0.150 |
| | | | % by mass | 0.500 | 0.500 | 0.500 | 0.500 | 0.333 | 0.667 | 0.500 |
| | Compound | Compound 1 | parts by mass | 0.015 | | | | 0.01 | 0.02 | 0.015 |
| | (H) | | % by mass | 0.05 | | | | 0.033 | 0.067 | 0.05 |
| | including a | Compound 2 | parts by mass | | 0.015 | | | | | |
| | siloxane | | % by mass | | 0.050 | | | | | |
| | chain | Compound 3 | parts by mass | | | 0.015 | | | | |
| | | | % by mass | | | 0.050 | | | | |
| | | Compound 4 | parts by mass | | | | 0.015 | | | |
| | | | % by mass | | | | 0.050 | | | |
| | Metal | Tetraethoxysilane | parts by mass | 0.09 | 0.09 | 0.09 | 0.09 | 0.06 | 0.12 | 0.03 |
| | compound | | % by mass | 0.300 | 0.300 | 0.300 | 0.300 | 0.200 | 0.400 | 0.100 |
| | (G) | Triethoxysilane | parts by mass | | | | | | | |
| | | | % by mass | | | | | | | |
| | | Tetramethoxysilane | parts by mass | | | | | | | |
| | | | % by mass | | | | | | | |
| | | Ethyl silicate 40 | parts by mass | | | | | | | |
| | | | % by mass | | | | | | | |
| | Solvent (I) | Isooctane | parts by mass | 29.75 | 29.75 | 29.75 | 29.75 | 29.83 | 29.66 | 29.75 |
| | | | % by mass | 99.15 | 99.15 | 99.15 | 99.15 | 99.43 | 98.87 | 99.35 |

| | | | | | | | | |
|---|---|---|---|---|---|---|---|---|
| F + H + G | % by mass | 0.85 | 0.85 | 0.85 | 0.85 | 0.57 | 1.13 | 0.65 |
| (H + G)/(F + H + G) | mass ratio (%) | 41.2 | 41.2 | 41.2 | 41.2 | 41.2 | 41.2 | 23.1 |

| | | | | Composition | Composition | Composition | Compo- | Compo- | Compo- |
|---|---|---|---|---|---|---|---|---|---|
| | | | | 8 | 9 | 10 | sition 11 | sition 12 | sition 13 |
| Component | Polysiloxane (F) | | parts by mass | 0.150 | 0.030 | 0.020 | 0.100 | 0.100 | 0.100 |
| | | | % by mass | 0.500 | 0.297 | 0.099 | 0.333 | 0.333 | 0.333 |
| | Compound | Compound 1 | parts by mass | 0.015 | 0.03 | 0.05 | 0.01 | 0.01 | 0.01 |
| | (H) | | % by mass | 0.05 | 0.297 | 0.249 | 0.033 | 0.033 | 0.033 |
| | including a | Compound 2 | parts by mass | | | | | | |
| | siloxane | | % by mass | | | | | | |
| | chain | Compound 3 | parts by mass | | | | | | |
| | | | % by mass | | | | | | |
| | | Compound 4 | parts by mass | | | | | | |
| | | | % by mass | | | | | | |
| | Metal | Tetraethoxysilane | parts by mass | 0.18 | 0.03 | 0.043 | | | |
| | compound | | % by mass | 0.598 | 0.297 | 0.214 | | | |
| | (G) | Triethoxysilane | parts by mass | | | | 0.060 | | |
| | | | % by mass | | | | 0.200 | | |
| | | Tetramethoxysilane | parts by mass | | | | | 0.060 | |
| | | | % by mass | | | | | 0.200 | |
| | | Ethyl silicate 40 | parts by mass | | | | | | 0.060 |
| | | | % by mass | | | | | | 0.200 |
| | Solvent (I) | Isooctane | parts by mass | 29.75 | 10.00 | 20.00 | 29.83 | 29.83 | 29.83 |
| | | | % by mass | 98.85 | 99.11 | 99.44 | 99.43 | 99.43 | 99.43 |

| | | | | | | | |
|---|---|---|---|---|---|---|---|
| F + H + G | % by mass | 1.15 | 0.89 | 0.56 | 0.57 | 0.57 | 0.57 |
| (H + G)/(F + H + G) | mass ratio (%) | 56.4 | 66.7 | 82.3 | 41.2 | 41.2 | 41.2 |

In Table 6, compounds 1 to 4 are as follows. Compound 1: A compound having an average of n2 of 24 in the compound represented by formula (H3) (molecular weight calculated from the structural formula: 2212.52). Compound 2: A compound having an average of n4 of 24 in the compound represented by formula (H4) (molecular weight calculated from the structural formula: 1990.66). Compound 3: A compound having an average of n4 of 3 in the compound represented by formula (H4) (molecular weight calculated from the structural formula: 432.84). Compound 4: A compound having an average of n2 of 3 in the compound represented by formula (H3) (molecular weight calculated from the structural formula: 655.3).

### Examples 1 to 15

(Production of coating film)

A 5×5 cm² glass substrate (EAGLE XG, Corning Inc.) having a surface activated by an atmospheric pressure plasma treatment was placed so as to have an elevation angle of 45°, 500 μL of the composition for forming an intermediate layer was poured from the upper surface of a glass substrate and dried at normal temperature and humidity for 5 minutes, and then 500 μL of the composition for forming a liquid-repellent layer was poured thereon and air-dried at normal temperature and humidity for 1 day to form a coating film on the glass substrate.

### Comparative Example 1

A 5×5 cm² glass substrate (EAGLE XG, Corning Inc.) having a surface activated by an atmospheric pressure plasma treatment was placed so as to have an elevation angle of 45°, 500 μL of the composition for forming a liquid-repellent layer was poured from the upper surface of a glass substrate and air-dried at normal temperature and humidity for 1 day to form a coating film on the glass substrate.

The coating films obtained in the Examples and Comparative Example were evaluated in terms of the following item.

(Contact Angle)

The contact angle of water with respect to the coating film surface was measured by a θ/2 method with a water droplet amount of 3.0 μL using a contact angle measuring device “DM700” manufactured by Kyowa Interface Science Co., Ltd. Cases in which the contact angle was 95° or more were evaluated as having excellent water repellency.

(Sliding Speed)

Water was dropped onto the coating film surface, and water repellency was evaluated by the sliding speed of the water droplets on the coating film surface. Specifically, using a contact angle measuring device “DM700” manufactured by Kyowa Interface Science Co., Ltd., 50 μL of water was dropped onto a coating film surface on a glass substrate tilted at 20°, the time taken for the water droplet to slide 15 mm from the initial dropping position was measured, and the sliding speed (mm/sec) of the water droplet on the coating film surface was calculated. Cases where the sliding speed of the water droplet was 20 mm/sec or more were evaluated as having excellent water repellency.

(Wear Resistance)

Onto a coating film 2.5 mL of water was dropped, and a silicon sheet (SR-400, manufactured by Tigers Polymer Corporation) was brought into contact thereon. Then, in a state in which a load of 500 gf was applied from above on the silicon sheet, the coating film was rubbed with a silicon sheet 400 times for a distance of 20 mm under conditions of a reciprocating speed of 400 mm/min, the contact angles at three points in the center of the rubbed portion were each measured, and the number of times until two of the three points decreased to 85° or less was measured. When the number of times was 400 times or more, the wear resistance was evaluated to be excellent.

The types of the used composition for forming an intermediate layer and composition for forming a liquid-repellent layer, and the evaluation results of the obtained coating films are shown in Table 7.

TABLE 7

| | | Composition | Properties | | |
|---|---|---|---|---|---|
| | Composition | for forming | | | Rubbing |
| | for a liquid- | an | Contact | Sliding | resistance, |
| | repellent | intermediate | angle | speed | number |
| | layer | layer | ° | mm/sec | times |
| Example 1 | Composition | Composition | 102.1 | 48.96 | 1600 |
| | A | 1 | | | |
| Example 2 | Composition | Composition | 103.8 | 42.20 | 2400 |
| | A | 2 | | | |
| Example 3 | Composition | Composition | 103.8 | 43.04 | 1600 |
| | A | 3 | | | |
| Example 4 | Composition | Composition | 104.2 | 46.51 | 2400 |
| | A | 4 | | | |
| Example 5 | Composition | Composition | 102.1 | 61.61 | 1600 |
| | A | 5 | | | |
| Example 6 | Composition | Composition | 101.2 | 24.69 | 2800 |
| | A | 6 | | | |
| Example 7 | Composition | Composition | 100.1 | 26.55 | 1600 |
| | B | 1 | | | |
| Example 8 | Composition | Composition | 102.0 | 78.74 | 1600 |
| | C | 1 | | | |
| Example 9 | Composition | Composition | 101.4 | 62.02 | 1200 |
| | A | 7 | | | |
| Example 10 | Composition | Composition | 102.0 | 29.38 | 1600 |
| | A | 8 | | | |
| Example 11 | Composition | Composition | 101.0 | 39.35 | 800 |
| | A | 9 | | | |
| Example 12 | Composition | Composition | 102.1 | 73.85 | 400 |
| | A | 10 | | | |
| Example 13 | Composition | Composition | 103.7 | 78.01 | 2000 |
| | A | 11 | | | |
| Example 14 | Composition | Composition | 104.2 | 103.52 | 1200 |
| | A | 12 | | | |
| Example 15 | Composition | Composition | 102.3 | 87.04 | 1600 |
| | A | 13 | | | |
| Comparative | Composition | — | 103.0 | 1.83 | 400> |
| Example 1 | A | | | | |

In Examples 1 to 15, in which a mixed composition containing at least one metal compound (G) selected from a metal compound represented by the formula (G1) and a condensate thereof, the polysilazane (F), and the compound (H) including a siloxane chain was used as the composition for forming an intermediate layer, and a liquid-repellent layer was further formed on the intermediate layer, coating films having excellent wear resistance and room temperature curability were produced without impairing liquid repellency.

### INDUSTRIAL APPLICABILITY

The coating films obtained by using the composition of the present invention as a composition for forming an intermediate layer and then forming a liquid-repellent film on the intermediate layer had excellent wear resistance, and preferably also excellent room temperature curability, without impairing liquid repellency (in particular, water repellency). Therefore, the coating films are useful as a base material in display devices such as touch panel displays, optical elements, semiconductor devices, building materials, automobile parts, and nanoimprint technology. In addition, the composition for forming a liquid-repellent layer of the present invention can also be suitably used for an article such as a body, window glass (windshield, side glass, rear glass), a mirror, and a bumper in transportation equipment such as trains, automobiles, ships, and aircraft. Furthermore, the composition for forming a liquid-repellent layer of the present invention can also be used for outdoor applications such as the external walls of a building, tents, solar power generation modules, sound insulation boards, and concrete, as well as for fishing nets, insect nets, aquariums, and the like. Still further, the composition for forming a liquid-repellent layer of the present invention can be used for a part of various members in kitchens, bathrooms, washbasins, mirrors, toilet vicinity, as well as for various indoor equipment such as chandeliers, ceramics such as tiles, artificial marble, and air conditioners. Still further, the composition for forming a liquid-repellent layer of the present invention can also be used as an antifouling treatment for jigs, inner walls, pipes, and the like in factories. The composition for forming a liquid-repellent layer of the present invention is also suitable for goggles, spectacles, helmets, pachinko (mechanical gaming machine) equipment, textiles, umbrellas, playground equipment, soccer balls and the like. Still further, the composition for forming a liquid-repellent layer of the present invention can be used as an anti-adhesive agent for various packaging materials, such as food packaging materials, cosmetic packaging materials, and pot interiors.

1. A mixed composition comprising:
at least one metal compound (G) selected from a metal compound represented by the following formula (G1) and a condensate thereof;
a polysilazane (F); and
a compound (II) including a siloxane chain,
M(R^{g10})ᵣ(A^{g1})ₘ₋ᵣ (G1)
wherein M represents Al, Fe, In, Ge, Si, Ti, Sn, Zr, or Ta, R^{g10} represents a hydrocarbon chain-containing group or a hydrogen atom, r is 0 or 1, a plurality of A^{g10} each independently represent a hydrolyzable group, and m is an integer of 3 to 5 in accordance with the metal atom M.

2. The composition according to claim 1, wherein a mass ratio of the compound (H) including a siloxane chain and the metal compound (G) to the total mass of the polysilazane (F), the compound (H) including a siloxane chain, and the metal compound (0) is 5 to 95%.

3. The composition according to claim 1, wherein the polysilazane (F) has a structural unit represented by the following formula (f1): 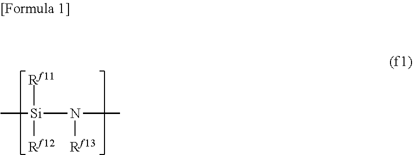
wherein R^{f11}, R^{f12}, and R^{f13} each independently represent a hydrogen atom, an optionally-substituted hydrocarbon group having 1 to 10 carbon atoms, or an alkylsilyl group.

4. The composition according to claim 3, wherein the polysilazane (F) has a structural unit (f2) in which at least one of R^{f11} and R^{f12} in formula (f1) is a hydrocarbon group having 1 to 10 carbon atoms.

5. The composition according to claim 4, wherein the polysilazane (F) has, in addition to the structural unit (f2), a structural unit represented by the following formula (f3): 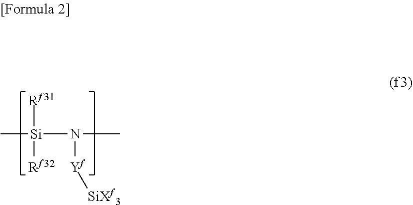
wherein and R^{f31} and R^{f32} each independently represent a hydrogen atom or a hydrocarbon group having 1 to 10 carbon atoms, Y¹ represents a divalent hydrocarbon group having 1 to 10 carbon atoms, and each of a plurality of X^{fs} independently represents a hydrolyzable group.

6. The composition according to claim 1, wherein the compound (H) including a siloxane chain is a compound represented by the following formula (H1): 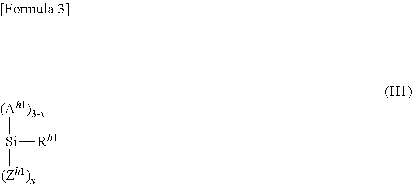
wherein R^{h1} represents a molecular chain having a trialkylsilyl group and a siloxane chain, each A^{h1} independently represents a hydrolyzable group, Z^{h1} represents a molecular chain having a trialkylsilyl group and a siloxane chain, a siloxane skeleton-containing group, or a hydrocarbon chain-containing group, a hydrogen atom included in the trialkylsilyl groups of R^{h1} and Z^{h1} is optionally replaced by a fluorine atom, and x represents an integer of 0 to 3.

7. The compound according to claim 6, wherein R^{h1} in formula (H1) is a group represented by the following formula (s3): 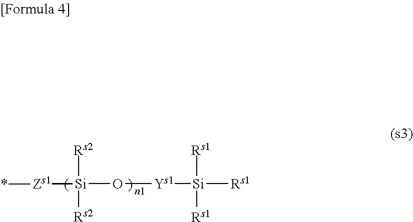
wherein each of a plurality of R^{s1} independently represents a hydrocarbon group or a trialkylsilyloxy group, a hydrogen atom included in the hydrocarbon group or the trialkylsilyloxy group is optionally replaced by a fluorine atom, each of a plurality of R^{s2} independently represents an alkyl group having 1 to 10 carbon atoms, n i denotes an integer of 1 or more, Z^{s1} represents —O— or a divalent hydrocarbon group, —CH₂— included in the divalent hydrocarbon group is optionally replaced by —O—, Y^{s1} represents a single bond or —Si(R^{s2})₂-L^{s1}-, the L^{s1} represents a divalent hydrocarbon group, and —CH₂— included in the divalent hydrocarbon group is optionally replaced by —O—.

8. The composition according to claim 1, wherein the total amount of the polysilazane (F), the compound (H) including a siloxane chain, and the metal compound (G) is 0.2% by mass or more and less than 2.6% by mass.

9. The composition according to claim 1, wherein the amount of the compound (H) including a siloxane chain is less than 0.3% by mass.

10. The composition according to claim 1, which is for an intermediate layer between a base material and a liquid-repellent layer.

11. The composition according to claim 10, wherein the liquid-repellent layer is a film formed by a dehydration condensation reaction of a silanol group.
